(19) United States
(12) Patent Application Publication
(10) Pub. No.: US 2015/0339728 A1
(43) Pub. Date: Nov. 26, 2015

(54) AD SERVING AND INTELLIGENT IMPRESSION THROTTLING TECHNIQUES IMPLEMENTED IN ELECTRONIC DATA NETWORKS

(71) Applicant: Pubmatic, Inc., Redwood City, CA (US)

(72) Inventors: Kartik SURA, Pune (IN); Anand DAS, Sunnyvale, CA (US); Mahesh Arun BHOSALE, Pune (IN)

(21) Appl. No.: 14/282,355

(22) Filed: May 20, 2014

(51) Int. Cl. G06Q 30/02

(52) U.S. Cl. CPC G06Q 30/0272; G06Q 30/0277; G06Q 30/0273

(57) ABSTRACT

Various aspects are disclosed for enabling an advertising server to improve profitability by selectively and dynamically discriminating between the various ad server resources which are to be allocated towards servicing different incoming impressions. The ad server may be configured or designed to dynamically evaluate the parameters of each incoming impressions in order to assess the likelihood of that incoming impression being successfully filled by demand partners and/or advertising networks. At various times when conditions warrant, the ad server may selectively and dynamically choose to throttle or drop the servicing of selected incoming ad requests/impressions in order to minimize losses which may occur as a result of servicing ad requests/impressions which result in defaults.

### BACKGROUND

The present disclosure relates to online advertising techniques and, more particularly, relates to techniques for ad serving and intelligent impression throttling techniques implemented in electronic data networks.

A significant quantity of content published on the Internet is supported by advertisements (“ads”). Publishers of Internet-based content often make use of a robust infrastructure of ad networks and/or exchanges that handles the selection, placement, and insertion of ads in web pages. These ad networks and/or exchanges generally select from a set of available ads, based on various factors such as geographic location, subject matter, and the like, in an effort to present ads that are most likely to be maximize revenue in a given context. Advertisers pay the ad networks and/or exchanges for ad exposures based on, among other factors, expected or actual performance of the ad determined, for example, by counting the number of times users click on the ad. Accordingly, revenue can be increased by placing ads to maximize response and effectiveness.

As the online advertising industry continues to grow, the amount of control that publishers (entities who have an inventory of advertising space to sell) want with respect to selling this ad space inventory also grows. As a result, there is an increasing desire among publishers to carve out specific inventory buckets for their ad space inventory. On the advertiser side, advertisers are now increasingly particular about how much they will pay to place their ads on Web pages.

Various mechanisms for measuring performance and effectiveness of advertisements are available. One well-known measurement of ad performance is effective cost per mille (e-CPM), which indicates a cost (or price) of showing an ad one thousand times. e-CPM is therefore a measurement of revenue that a publisher can expect to receive from an ad network based on the number of impressions, or page views, of the content. e-CPM is often determined on an estimated basis. Revenue for an Internet publisher is maximized when an advertisement having high e-CPM is shown. Higher e-CPM means that an ad network is willing to pay more because of an expectation that an ad will be more effective.

In many situations, Internet publishers use several different ad networks and/or exchanges for their online advertising needs. Existing techniques for selecting advertisements often fail to perform effective comparisons among multiple ad networks and/or exchanges. Without comparisons among multiple ad networks, existing techniques fail to provide Internet publishers with sufficient information to most effectively monetize their inventory.

In addition, existing techniques often fail to provide Internet publishers with sufficiently detailed information concerning the effects of various factors that can affect the money that they earn. Such factors include, for example, user frequency, geography, context/vertical, rate of ads that are defaulting to another network, demographic data, and the like.

Without a systematic approach to optimize ad network and/or exchange selection, including selection among multiple ad networks and/or exchanges and effective handling of defaults, publishers can lose a significant amount of advertising revenue.

### BRIEF DESCRIPTION OF THE DRAWINGS

FIG. 1 illustrates a simplified block diagram of a specific example embodiment of an Advertising Network 100.

FIG. 2 is a block diagram showing an example embodiment of entities and interactions for implementing various aspects of the online advertising techniques disclosed herein.

FIG. 3A is a block diagram depicting an overall architecture for implementing various aspects of the online advertising techniques disclosed herein.

FIG. 3B is a block diagram illustrating data flow for an embodiment for implementing various aspects of the online advertising techniques disclosed herein.

FIG. 4 shows an example flow diagram of an Impression Throttling Triggering Procedure in accordance with a specific embodiment.

FIG. 5 shows an example flow diagram of an Ad Request Servicing Procedure in accordance with a specific embodiment.

FIG. 6 shows an example flow diagram of an Impression Classification Procedure in accordance with a specific embodiment.

FIG. 7 shows an example flow diagram of an Impression Processing Procedure in accordance with a specific embodiment.

FIGS. 8-12 show various example data tables which have been populated with sample historical data relating to the processing of incoming impressions by one or more ad servers.

FIG. 13 illustrates an example embodiment of an ad server system which may be used for implementing various aspects/features described herein.

### DETAILED DESCRIPTION OF EXAMPLE EMBODIMENTS

### Overview

As described in greater detail herein, various aspects are disclosed for enabling an Advertising Service Provider System (e.g., which includes one or more ad servers) to improve profitability by selectively and dynamically discriminating between the various ad server resources which are to be allocated towards servicing different incoming impressions. Additional aspects are disclosed herein for enabling an ad server to dynamically evaluate the parameters of each incoming impressions in order to assess the likelihood of that incoming impression being successfully filled by demand partners and/or advertising networks. At various times when conditions warrant, the ad server may selectively and dynamically choose to throttle or drop the servicing of selected incoming ad requests/impressions in order to minimize losses which may occur as a result of servicing ad requests/impressions which result in defaults.

One aspect disclosed herein is directed to different methods, systems, and computer program products for facilitating servicing of ad requests over an electronic data network. In at least one embodiment, various method(s), system(s) and computer program product(s) may be operable to cause at least one processor to execute a plurality of instructions for: receiving, at a first ad server, a first ad request from a remote device, the first ad request including information relating to a first ad impression to be displayed in connection with a display of a first web page at an end user's device, the first web page being associated with a first publisher, the first ad request further including information relating to a first set of impression parameters associated with the first ad impression; identifying, at the first ad server, a first impression parameter value relating to a first impression parameter of the first set of impression parameters; dynamically determining, using the first impression parameter value, a first historical fill rate value representing an aggregate fill rate of a first set of previously processed impressions each having a respective impression parameter value which matches the first impression parameter value; determining if the first historical fill rate value meets or exceeds a first set of minimum threshold fill rate criteria; if it is determined that the first historical fill rate value does not meet the first set of minimum threshold fill rate criteria, processing the first ad impression at the first ad server in accordance with a first set of Impression Throttling procedures; and wherein the processing of the first ad impression in accordance with a first set of Impression Throttling procedures causes the first ad server to dynamically reduce an amount of ad server resources allocated for processing the first ad impression.

In at least one embodiment, various method(s), system(s) and computer program product(s) may be further operable to cause at least one processor to execute additional instructions for: causing the first ad server to perform at least one action selected from a group comprising: (a) omitting performance of a real-time bid (RTB) auction in connection with the first ad impression; (b) reducing a timeout parameter associated with RTB ad solicitation request calls to thereby reduce an amount of time spent in waiting for responses to the RTB ad solicitation request calls to be received at the first ad server during servicing of the first ad impression; (c) omitting performance of one or more ad solicitation request calls to one or more mobile advertising networks during servicing of the first ad impression; (d) reducing a timeout parameter associated with mobile advertising network ad solicitation request calls to thereby reduce an amount of time spent in waiting for responses to the mobile advertising network ad solicitation request calls to be received at the first ad server during servicing of the first ad impression; (e) reducing a Call Threshold value to thereby reduce a number of mobile advertising network ad solicitation request calls or hops to be performed by the first ad server in servicing the first ad impression; and (f) rejecting or dropping the first ad impression.

In at least one embodiment, various method(s), system(s) and computer program product(s) may be further operable to cause at least one processor to execute additional instructions for: processing the first ad impression at the first ad server in accordance with a second set of procedures if it is determined that the first historical fill rate value meets or exceeds the first set of minimum threshold fill rate criteria; and wherein the processing of the first ad impression in accordance with a second set of Impression Throttling procedures does not causes the first ad server to dynamically reduce an amount of ad server resources allocated for processing the first ad impression.

In at least one embodiment, various method(s), system(s) and/or computer program product(s) may be further operable to cause at least one processor to execute additional instructions for: tracking, at the ad server, occurrences of timeout events which are detected during a first time interval, the timeout events relating to advertising network calls initiated by the ad server; if it is determined that the detected occurrences of timeout events meets or exceeds a first set of threshold criteria, configuring the first set of Impression Throttling procedures to include a first set of Strict Throttling procedures; and if it is determined that the detected occurrences of timeout events meets or exceeds a second set of threshold criteria, configuring the first set of Impression Throttling procedures to include a first set of Lenient Throttling procedures.

In at least one embodiment, various method(s), system(s) and/or computer program product(s) may be further operable to cause at least one processor to execute additional instructions for: detecting, at the ad server, an occurrence first set of events and conditions; determining if the first set of events and conditions conforms with a first set of criteria; determining if the first set of events and conditions conforms with a second set of criteria; if it is determined that the first set of events and conditions conforms with the first set of criteria, enabling use of Impression Throttling procedures at the ad server in connection with processing of incoming ad impressions; and if it is determined that the first set of events and conditions conforms with the second set of criteria, disabling use of Impression Throttling procedures at the ad server in connection with processing of incoming ad impressions.

In at least one embodiment, various method(s), system(s) and/or computer program product(s) may be further operable to cause at least one processor to execute additional instructions for: identifying, at the first ad server, a second impression parameter value relating to a second impression parameter of the second set of impression parameters; dynamically determining, using the second impression parameter value, a second historical fill rate value representing an aggregate fill rate of a second set of previously processed impressions each having a respective impression parameter value which matches the second impression parameter value; determining if the second historical fill rate value meets or exceeds a second set of minimum threshold fill rate criteria; if it is determined that the second historical fill rate value does not meet the second set of minimum threshold fill rate criteria, processing the first ad impression at the first ad server in accordance with a second set of Impression Throttling procedures; and wherein the processing of the first ad impression in accordance with a second set of Impression Throttling procedures causes the first ad server to dynamically reduce an amount of ad server resources allocated for processing the first ad impression.

Another aspect disclosed herein is directed to different methods, systems, and computer program products for facilitating servicing of ad requests over an electronic data network. In at least one embodiment, various method(s), system(s) and computer program product(s) may be operable to cause at least one processor to execute a plurality of instructions for: receiving, at a first ad server, a first ad request from a remote device, the first ad request including information relating to a first ad impression to be displayed in connection with a display of a first web page at an end user's device, the first web page being associated with a first publisher, the first ad request further including information relating to a first set of impression parameters associated with the first ad impression; identifying, at the first ad server, a first impression parameter value relating to a first impression parameter of the first set of impression parameters; dynamically determining, using the first impression parameter value, a first historical fill rate value representing an aggregate fill rate of a first set of previously processed impressions each having a respective impression parameter value which matches the first impression parameter value; determining if the first historical fill rate value satisfies a first set of minimum threshold fill rate criteria; determining, using historical fill rate information relating to the first impression parameter, a first fill rate dispersion indicator relating to the first impression parameter, the first fill rate dispersion indicator being indicative of an amount of variation or dispersion relating to a distribution of historical fill rate values associated with the first impression parameter; determining if the first fill rate dispersion indicator satisfies minimum dispersion threshold criteria; if it is determined that the first fill rate dispersion indicator satisfies the minimum dispersion threshold criteria, and if it is determined that the first historical fill rate value does not satisfy the first set of minimum threshold fill rate criteria, processing the first ad impression at the first ad server in accordance with a first set of Impression Throttling procedures; and wherein the processing of the first ad impression in accordance with a first set of Impression Throttling procedures causes the first ad server to dynamically reduce an amount of ad server resources allocated for processing the first ad impression.

In at least one embodiment, various method(s), system(s) and/or computer program product(s) may be further operable to cause at least one processor to execute additional instructions for performing a first set of activities in response to determining that the first fill rate dispersion indicator does not satisfy the minimum dispersion threshold criteria, the first set of activities including causing the at least one processor to execute additional instructions for: identifying, at the first ad server, a second impression parameter value relating to a second impression parameter of the second set of impression parameters; dynamically determining, using the second impression parameter value, a second historical fill rate value representing an aggregate fill rate of a second set of previously processed impressions each having a respective impression parameter value which matches the second impression parameter value; determining if the second historical fill rate value satisfies the first set of minimum threshold fill rate criteria; determining, using historical fill rate information relating to the second impression parameter, a second fill rate dispersion indicator relating to the second impression parameter, the second fill rate dispersion indicator being indicative of an amount of variation or dispersion relating to a distribution of historical fill rate values associated with the second impression parameter; determining if the second fill rate dispersion indicator satisfies the minimum dispersion threshold criteria; and if it is determined that the second fill rate dispersion indicator satisfies the minimum dispersion threshold criteria, and if it is determined that the second historical fill rate value does not satisfy the first set of minimum threshold fill rate criteria, processing the first ad impression at the first ad server in accordance with the first set of Impression Throttling procedures.

Various objects, features and advantages of the various aspects described or referenced herein will become apparent from the following descriptions of its example embodiments, which descriptions should be taken in conjunction with the accompanying drawings.

### Specific Example Embodiments

Various techniques will now be described in detail with reference to a few example embodiments thereof as illustrated in the accompanying drawings. In the following description, numerous specific details are set forth in order to provide a thorough understanding of one or more aspects and/or features described or reference herein. It will be apparent, however, to one skilled in the art, that one or more aspects and/or features described or reference herein may be practiced without some or all of these specific details. In other instances, well known process steps and/or structures have not been described in detail in order to not obscure some of the aspects and/or features described or reference herein.

One or more different inventions may be described in the present application. Further, for one or more of the invention(s) described herein, numerous embodiments may be described in this patent application, and are presented for illustrative purposes only. The described embodiments are not intended to be limiting in any sense. One or more of the invention(s) may be widely applicable to numerous embodiments, as is readily apparent from the disclosure. These embodiments are described in sufficient detail to enable those skilled in the art to practice one or more of the invention(s), and it is to be understood that other embodiments may be utilized and that structural, logical, software, electrical and other changes may be made without departing from the scope of the one or more of the invention(s). Accordingly, those skilled in the art will recognize that the one or more of the invention(s) may be practiced with various modifications and alterations. Particular features of one or more of the invention(s) may be described with reference to one or more particular embodiments or figures that form a part of the present disclosure, and in which are shown, by way of illustration, specific embodiments of one or more of the invention(s). It should be understood, however, that such features are not limited to usage in the one or more particular embodiments or figures with reference to which they are described. The present disclosure is neither a literal description of all embodiments of one or more of the invention(s) nor a listing of features of one or more of the invention(s) that must be present in all embodiments.

Headings of sections provided in this patent application and the title of this patent application are for convenience only, and are not to be taken as limiting the disclosure in any way.

Devices that are in communication with each other need not be in continuous communication with each other, unless expressly specified otherwise. In addition, devices that are in communication with each other may communicate directly or indirectly through one or more intermediaries.

A description of an embodiment with several components in communication with each other does not imply that all such components are required. To the contrary, a variety of optional components are described to illustrate the wide variety of possible embodiments of one or more of the invention(s).

Further, although process steps, method steps, algorithms or the like may be described in a sequential order, such processes, methods and algorithms may be configured to work in alternate orders. In other words, any sequence or order of steps that may be described in this patent application does not, in and of itself, indicate a requirement that the steps be performed in that order. The steps of described processes may be performed in any order practical. Further, some steps may be performed simultaneously despite being described or implied as occurring non-simultaneously (e.g., because one step is described after the other step). Moreover, the illustration of a process by its depiction in a drawing does not imply that the illustrated process is exclusive of other variations and modifications thereto, does not imply that the illustrated process or any of its steps are necessary to one or more of the invention(s), and does not imply that the illustrated process is preferred.

When a single device or article is described, it will be readily apparent that more than one device/article (whether or not they cooperate) may be used in place of a single device/article. Similarly, where more than one device or article is described (whether or not they cooperate), it will be readily apparent that a single device/article may be used in place of the more than one device or article.

The functionality and/or the features of a device may be alternatively embodied by one or more other devices that are not explicitly described as having such functionality/features. Thus, other embodiments of one or more of the invention(s) need not include the device itself.

Techniques and mechanisms described or reference herein will sometimes be described in singular form for clarity. However, it should be noted that particular embodiments include multiple iterations of a technique or multiple instantiations of a mechanism unless noted otherwise.

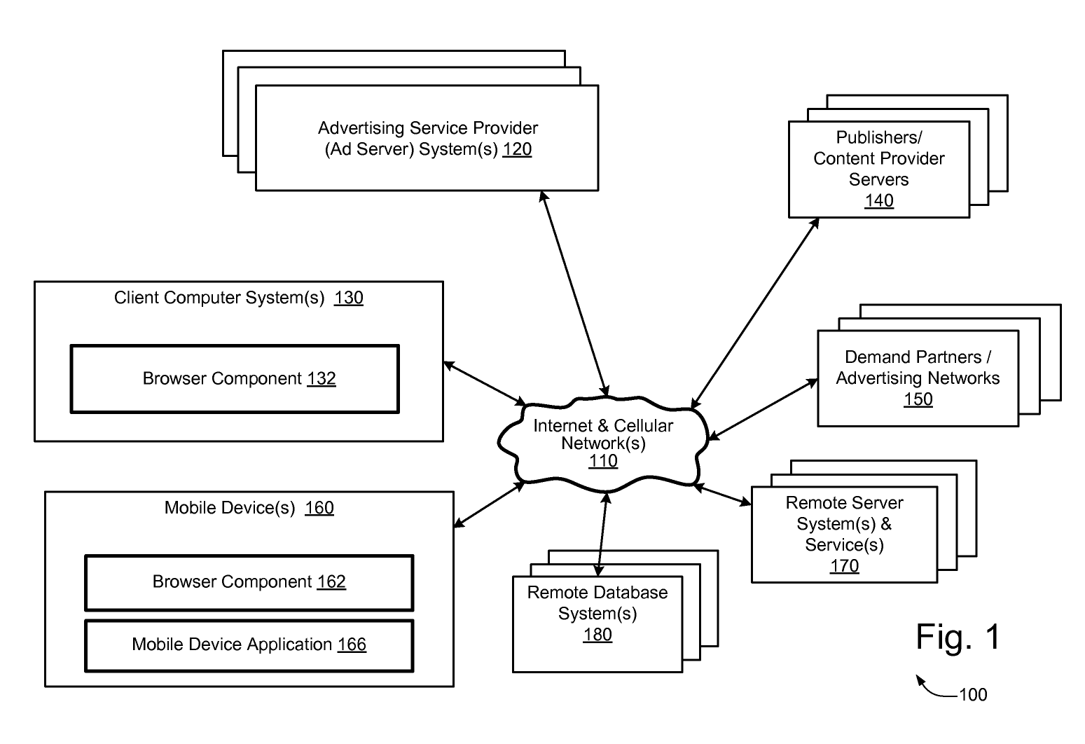

FIG. 1 illustrates a simplified block diagram of a specific example embodiment of an Advertising Network 100. As described in greater detail herein, different embodiments of Advertising Networks may be configured, designed, and/or operable to provide various different types of operations, functionalities, and/or features generally relating to advertising technology.

According to different embodiments, at least some Advertising Network(s) and Advertising System(s) disclosed herein may be configured, designed, and/or operable to provide a number of different advantages and/or benefits and/or may be operable to initiate, and/or enable various different types of operations, functionalities, and/or features, such as, for example, one or more of those described and/or referenced herein.

According to different embodiments, at least a portion of the various functions, actions, operations, and activities performed by one or more component(s) of the Advertising Network may be initiated in response to detection of one or more conditions, events, and/or other criteria satisfying one or more different types of minimum threshold criteria, such as, for example, one or more of those described and/or referenced herein. Further, according to different embodiments, at least a portion of the various types of functions, operations, actions, and/or other features provided by the various system(s) and component(s) of the Advertising Network may be implemented at one or more client systems(s), at one or more server systems (s), and/or combinations thereof.

According to different embodiments, the Advertising Network 100 may include a plurality of different types of components, devices, modules, processes, systems, etc., which, for example, may be implemented and/or instantiated via the use of hardware and/or combinations of hardware and software. For example, as illustrated in the example embodiment of FIG. 1, the Advertising Network may include one or more of the following types of systems, components, devices, processes, etc. (or combinations thereof):
Advertising Service Provider (Ad Server) System(s) 120, which, for example, may be operable to perform and/or implement various types of ad server functions, operations, actions, and/or other features such as those described or referenced herein.
Publisher/Content Provider Servers(s) 140, which, for example, may be configured or designed to render and provide access to various internet-based web sites, web pages, etc.
Client Computer System (s) 130.
Demand Partners/Advertising Networks 150, which, for example, may be operable to serve or supply ads, such as demand side partners (DSP), ATDs, RTB networks, mobile advertising networks (e.g., Adnet, S2S), ad campaign networks, trading desks and advertisers, such as Ford, Proctor & Gamble, and Coca-Cola.
Internet & Cellular Network(s) 110.
Remote Database System(s) 180.
Remote Server System(s) & Service(s) 170, which, for example, may include, but are not limited to, one or more of the following (or combinations thereof):
   Content provider servers/services
   Media Streaming servers/services
   Database storage/access/query servers/services
   Financial transaction servers/services
   Payment gateway servers/services
   Electronic commerce servers/services
   Event management/scheduling servers/services
   Etc.
Mobile Device(s) 160.
etc.

As illustrated in the example embodiment of FIG. 1, the Client Computer System(s) 130 and/or Mobile Device(s) 160 may each include browser component(s) (e.g., 132, 162). As used herein, the term “browser component”, “web browser” and/or the act of “browsing” may be defined to include any type of application, hardware, and/or combination of hardware/software implemented at a computing device which facilitates or enables the computing device to access information and/or resources from local and/or wide area networks such as, for example, the Internet and/or World Wide Web. Examples of such computing devices may include PDAs, smart phones, notebook computers, tablets, netbooks, desktop computing systems, server systems, cloud computing systems, network devices, personal computers, mobile devices, Smart TVs, wearable technology (such as intelligent glasses, watches, etc.) and/or other computing devices which include web browser functionality for accessing Internet-based websites and web pages.

According to different embodiments, the Advertising Service Provider System 120 may include one or more ad servers which may communicate directly and/or indirectly with other entities of the Advertising Network(s). One goal of Publisher(s)/Content Provider(s) 140 is to obtain the highest CPM price (i.e., cost per thousand ad impressions) for each of its advertising segments. One goal of the Demand Partners/Advertising Networks 150 is to serve online ads that reach as narrow and targeted an audience as possible (e.g., serve ads that are most effective). As illustrated in the example embodiment of FIG. 1, there is communication between Publisher(s)/Content Provider(s) 140 and Advertising Service Provider System 120 and communication between Advertising Service Provider System 120 and Demand Partners/Advertising Networks 150.

In at least one embodiment, Demand Partners/Advertising Networks 150 may include, for example, one or more of the following (or combinations thereof):
Advertisers and/or ad serving entities who participate in real-time bidding or auctioning of ad impressions.
API-based ad serving networks such as “Adnet” or Server-to-Server (“S2S”). In some embodiments, different API-based ad serving networks may be classified as either Beacon Based Counting (BBC) Networks or Server Side Counting Networks (Non BBC). Typically, a Server Side Counting Network only counts an impression (e.g., for CPM purposes) when the network responds with a valid creative. This may also be referred to as Server based counting (e.g., an impression is counted once the creative is returned). Alternatively, a Beacon Based Counting Network counts an impression when the creative is rendered (e.g., via use of a beacon). For example, in Beacon based Counting (BBC), an impression is counted by the network once the ad serving beacon is executed).

Generally, if the advertiser/ad serving entity is assured that their ad will be seen by the right audience, the advertiser/ad serving entity would be willing to pay more for placing the ad. One role of Advertising Service Provider System 120 is to facilitate reaching both these goals by acting as an ad serving broker between the two entities (e.g., Publisher(s)/Content Provider(s) 140 and Demand Partners/Advertising Networks 150).

Some publisher(s) and/or content provider(s) may desire to exercise more control in determining minimum (floor) e-CPM prices for their online advertising spots. Additionally, some publisher(s) and/or content provider(s) may desire to create, carve out, and/or allocate specific ad space inventory buckets. For example, an online publisher or content provider may have 100 ad spots that it wants to fill. A certain number of the spots, for example 40, are on web pages that are most likely viewed by viewers who earn above $80,000 annual income, live in metropolitan areas in the U.S., and may be either male or female. Another 35 spots are likely to be viewed by people between the ages of 18-35 who are interested in sports. Another 23 spots are likely viewed by people ages 55-70, male or female, and interested in travel, and so on. Of course, many more categories can be used to describe these buckets and they can be much more specific. Some publisher(s) and/or content provider(s) may desire to set a floor e-CPM for each bucket. The floor e-CPM for ad segments associated with the first bucket described in the above example (e.g., male or female viewers who earn above $80,000 annual income, live in metropolitan areas in the U.S.) may be higher than the floor e-CPM for ad spots associated with the second bucket (e.g., viewed by the 18-35 year old sports enthusiasts). The Publisher(s)/Content Provider(s) may be provided with the ability to exercise fine grained control over the pricing of their respective ad spots. For example, an online publisher or content provider may set floor e-CPMs which are more economically feasible for advertisers and/or may set floor e-CPMs which advertisers are more willing to pay.

From the advertiser/ad serving entity perspective, giving the Publisher(s)/Content Provider(s) more control over ad serving is also more appealing. An advertiser/ad serving entity such as Nike would be more willing to pay a higher floor e-CPM for placing an ad that is more likely to be viewed by people interested in sports and are of a certain age range. Similarly, a luxury brand advertiser/ad serving entity is also more likely to pay a higher e-CPM for placing an ad on a page that is more likely to be viewed by male or female viewers having a high annual salary, are between certain ages, and live in metropolitan areas where the luxury brand has stores. There is a wide variety of such advertiser/ad serving entities catering to audiences or markets having a specific demographic or socio-economic background, and having other characteristics. Accordingly, publisher(s) and/or content provider(s) may desire to create different tiers or types of advertising buckets, each with its own respective floor e-CPM that can cater to each of these groups.

However, because it may not be practical or desirable for Publisher(s)/Content Provider(s) to communicate directly with Advertiser/Ad Serving Entities to obtain the highest e-CPM floor price that the market is willing to pay, advertising service providers (such as, for example, Advertising Service Provider System 120) may be employed to facilitate communication between the Publisher(s)/Content Provider(s), web page viewer (e.g., client/mobile system end user), and the Advertiser(s)/AD Serving Entities. Some of the more larger and well-known Publishers/Content Providers may also set floor e-CPMs for specific advertiser/ad serving entities who are associated with specific Agency Trading Desks (ATDs) and/or Demand-Side Platforms (DSPs) that would like to advertise to certain users which match specific demography and geography characteristics. For example, if a user is female, between the ages of 25-35 and lives in London, the Publisher(s)/Content Provider(s) will ask for a lower e-CPM if the advertiser/ad serving entity is Nike and is through DSP1 and an even lower e-CPM if it is Nike through DSP2.

As is well known in the industry, an ad is served after a user has downloaded a Web page into the web browser of the end user's computer or mobile device. The code comprising the Web page (most often HTML) is executed by the browser and the ads are served to the end user's computing device from the ad source. In at least one embodiment, the entity serving the ad may be the Advertising Service Provider System 120 which receives it from an Demand Partners/Advertising Networks 150. When the viewer goes to a web site or web page, and the HTML for the site is executed in the end user's browser, the end user's user identifier information is available to the publisher/content provider. In at least one embodiment, the user identifier information may be defined to include information which may be used to uniquely identify a specific user or a collection of users. A variety of different methods and/or techniques may be used to identify, acquire and/or store the user identifier information in one or more user identifier information files. An example of one type of user identifier information file is a cookie (also known as an HTTP cookie, web cookie, or browser cookie). The user identifier information file (herein, “UII File”) is interpreted by the code in the publisher/content provider's web page and then an HTTP call is made to the Advertising Service Provider System with certain UII File parameters. Certain information in the UII File is used by the publisher/content provider and the Advertising Service Provider System to enable serving the most appropriate ad for the ad segments on the web page(s) being loaded on the end user's computing device. In one embodiment, this information may include a user ID (UID) and a system ID (SID), as well as other information described and/or referenced herein.

In at least one embodiment, the Advertising Service Provider System may be operable to utilize and/or generate various different types of data and/or other types of information when performing specific tasks and/or operations. This may include, for example, input data/information and/or output data/information. For example, in at least one embodiment, the Advertising Service Provider System may be operable to access, process, and/or otherwise utilize information from one or more different types of sources, such as, for example, one or more local and/or remote memories, devices and/or systems. Additionally, in at least one embodiment, the Advertising Service Provider System may be operable to generate one or more different types of output data/information, which, for example, may be stored in memory of one or more local and/or remote devices and/or systems. Examples of different types of input data/information and/or output data/information which may be accessed and/or utilized by the Advertising Service Provider System may include, but are not limited to, one or more of those described and/or referenced herein.

According to specific embodiments, multiple instances or threads of the Advertising Service Provider System may be concurrently implemented and/or initiated via the use of one or more processors and/or other combinations of hardware and/or hardware and software. For example, in at least some embodiments, various aspects, features, and/or functionalities of the Advertising Service Provider System may be performed, implemented and/or initiated by one or more of the various systems, components, systems, devices, procedures, processes, etc., described and/or referenced herein.

In at least one embodiment, one or more Advertising Service Provider Systems may access and/or utilize information from one or more associated databases. In at least one embodiment, at least a portion of the database information may be accessed via communication with one or more local and/or remote memory devices. Examples of different types of data which may be accessed by the Advertising Service Provider System may include, but are not limited to, one or more of those described and/or referenced herein.

According to different embodiments, various different types of encryption/decryption techniques may be used to facilitate secure communications between devices in Advertising Service Provider System(s) and/or Advertising Service Provider System(s). Examples of the various types of security techniques which may be used may include, but are not limited to, one or more of the following (or combinations thereof): random number generators, SHA-1 (Secured Hashing Algorithm), MD2, MD5, DES (Digital Encryption Standard), 3DES (Triple DES), RC4 (Rivest Cipher), ARC4 (related to RC4), TKIP (Temporal Key Integrity Protocol, uses RC4), AES (Advanced Encryption Standard), RSA, DSA, DH, NTRU, and ECC (elliptic curve cryptography), PKA (Private Key Authentication), Device-Unique Secret Key and other cryptographic key data, SSL, etc. Other security features contemplated may include use of well known hardware-based and/or software-based security components, and/or any other known or yet to be devised security and/or hardware and encryption/decryption processes implemented in hardware and/or software.

It will be appreciated that the Advertising Network of FIG. 1 is but one example from a wide range of Advertising Network embodiments which may be implemented. Other embodiments of the Advertising Network (not shown) may include additional, fewer and/or different components/features that those illustrated in the example Advertising Network embodiment of FIG. 1.

Generally, the advertising techniques described herein may be implemented in hardware and/or hardware+software. For example, they can be implemented in an operating system kernel, in a separate user process, in a library package bound into network applications, on a specially constructed machine, or on a network interface card. In a specific embodiment, various aspects described herein may be implemented in software such as an operating system or in an application running on an operating system.

Hardware and/or software+hardware hybrid embodiments of the advertising techniques described herein may be implemented on a general-purpose programmable machine selectively activated or reconfigured by a computer program stored in memory. Such programmable machine may include, for example, mobile or handheld computing systems, PDA, smart phones, notebook computers, tablets, netbooks, desktop computing systems, server systems, cloud computing systems, network devices, etc.

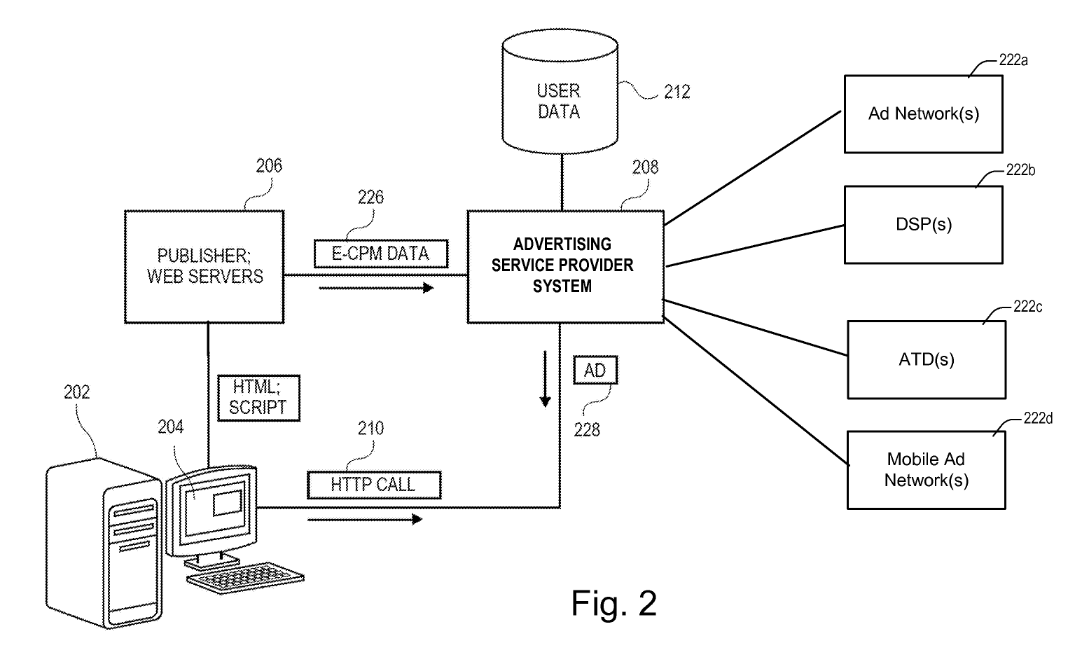

FIG. 2 is a block diagram showing an example embodiment of entities and interactions for implementing various aspects of the online advertising techniques disclosed herein. The example embodiment of FIG. 2 shows a user computing device 202 executing a browser 204. The end user goes to a certain Web site 206, for example, a blog about traveling. Code for displaying the Web site executes in the end user's browser 204. In the code there is a script for displaying an ad. The ad is served by an advertising service provider 208. An HTTP call 210 is made from user computing device 202 to advertising service provider 208 that contains a UID and an SID. The advertising service provider uses the SID and UID to retrieve information on the end user. The advertising service provider may have data on more than 500 million unique users (individuals). The data it has on the individuals includes age range, gender, preferences, demographic information, geographic location, socio-economic data (e.g., income, nationality, race, etc.), among other data. The advertising service provider databases 212 may be indexed by UID to obtain user or segment data. This data is searched in real time. In one embodiment, the publisher's Web page may be held until the look-up and ad bidding is done. The Web page is displayed when an ad has been selected and is available to be served and displayed with the Web page.

The advertising service provider then places the ad spot for real-time bidding (RTB) (that is, it starts a bidding process) among various selected Ad Network(s), which, for example, may include, but are not limited to, one or more of the following (or combinations thereof): selected Ad Network(s), Demand-Side Platforms (DSPs) 222b, Agency Trading Desks (ATDs) 222c, ad campaign server(s), and/or other types of advertisers.

In some embodiments, audience segment level and ad type level may be used to derive permutations that can be used by publisher 206 to set floor e-CPMs. For example, these bidders may be notified that there is an ad spot available on a travel blog Web site that is being viewed by a user, for example, in the 45-55 age range, living in San Francisco, male, Asian, has an annual income above $55,000, and so on.

There are numerous types of data that can be offered about the end user. The advertising service provider 208 may also state some requirements of the publisher 206, such as the quality of the ad (pixels, creatives, etc.). The advertising entities (214-224) can then bid on the spot. One desirable objective may be to obtain a match between user demographic data and features with an ad spot on the Web page. The publisher is able to set floor e-CPMs on numerous permutations of which a few basic examples are described here. A person of skill in the art of online ad serving would know how to take the controls and preferences and create many other types of permutations and appropriate floor e-CPMs. There are also relationships that the publisher may have with DSPs, ATDs, etc. that can be used to set floor e-CPMs.

Typically, it is not efficient for most publishers to directly deal with advertisers or DSPs (or other ad serving entities), since publishers typically do not have the desire or capability to deal with 50 or a 100 ad serving entities and thousands of advertisers in real time to serve ads at e-CPMs that are acceptable to both sides. As a result, publishers typically rely upon ad service providers (e.g., ad servers) to facilitate this process.

Various aspects of advertising service provider techniques are described herein for enabling online publishers and content providers to have more granular control over setting e-CPM floor prices for ads served on their web sites and related web pages. In one embodiment, a Floor Rule Engine can be implemented, for example as a module of a system (referred to herein as an Advertising Service Provider Private Marketplace), which allows the publisher to set floor pricing at a granular level. The Floor Rule Engine allows the publisher to set the e-CPM floor price using any combination of different entities. Each such parameter is referred to as a rule. Rules can be prioritized as desired.

Without the advertising service provider, the publisher would not be able to effectively use these controls or use them at all to set e-CPM floors. However, this is now possible because the publisher has the benefit of the advertising service provider's ability to get a profile of the end user/audience viewing the Web site in real-time. Finally, the ad 228 by the winning ad serving entity is served to user Web browser 204 and displayed in the Web page which can then complete loading.

As noted above, the number of parameters and categories that may be used to sell online ads has increased significantly. The advertising service provider is able to obtain and has stored massive amounts of data on hundreds of millions of users in its databases. Because of this large volume of data on users that is now available, the advertising service provider can enable the publisher a level of control in filling its ad spots that was previously not available. This information can be searched and the bidding process can occur as a Web page is loading. Once an ad has been selected (i.e., there is a winning bid), the ad is served by the advertising service provider to the end user's browser and displayed on the Web page. That user is now presented with an ad that is very likely of high interest to him or her.

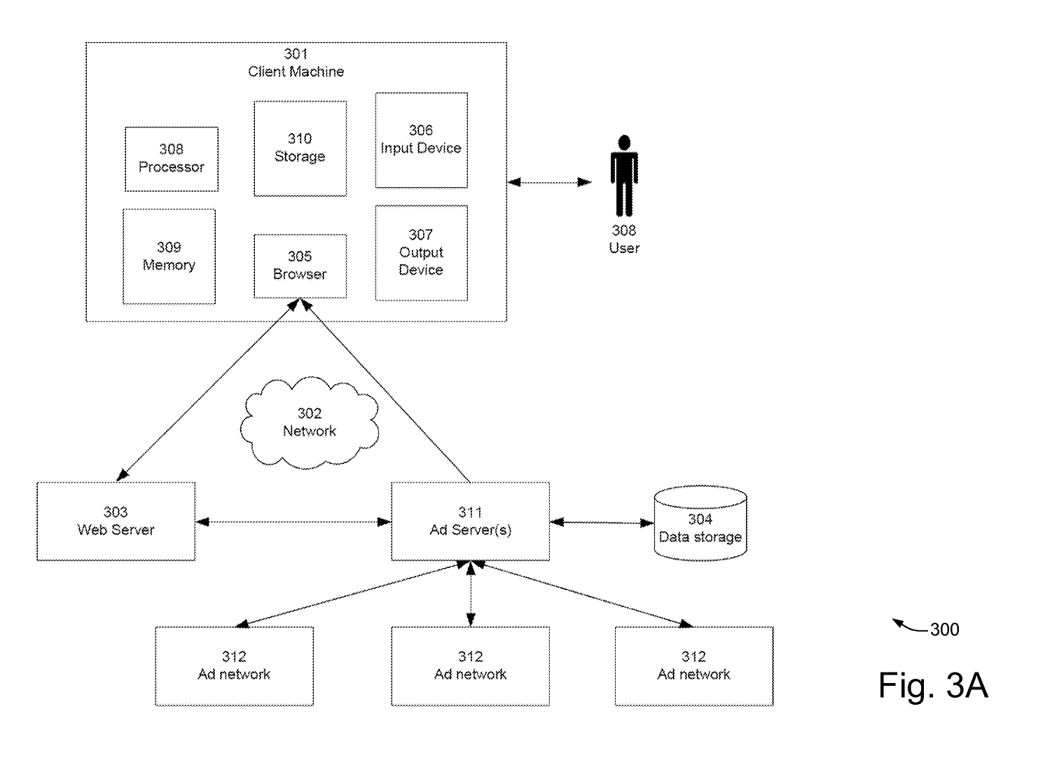

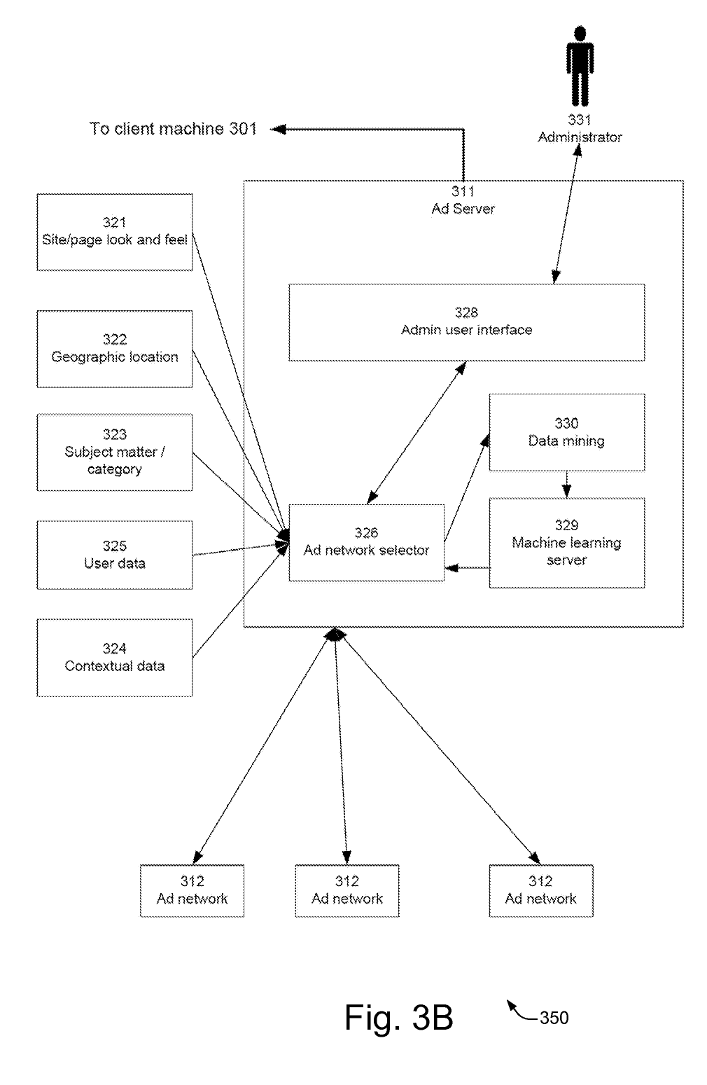

FIG. 3A is a block diagram depicting an overall architecture for implementing various aspects of the online advertising techniques disclosed herein. As illustrated in the example embodiment of FIG. 3A, client machine 301 communicates with server 303 across a network 302 such as the Internet, using well known protocols for such network communications. Client machine 301 can be a personal computer, computing device, or other electronic device such as a kiosk, telephone, cellular telephone, handheld computer, personal digital assistant, or the like. Client machine 301 includes, in one embodiment: processor 308; memory 309; storage 310; input device 306 such as a keyboard, mouse, touchpad, or the like; output device 307 such as a display screen; and other hardware components as are well known for computing devices and/or other electronic devices. Client machine 301 may run an operating system such as Microsoft Windows Vista, available from Microsoft Corporation of Redmond, Wash., or any other suitable operating system.

In one embodiment, browser software 305 runs on client machine 301 enabling user 308 to view content and interact with web pages available on the World Wide Web and delivered to client machine 301 via network 302. One example of browser 305 is Microsoft Internet Explorer, available from Microsoft Corporation of Redmond, Wash.

In one embodiment, an Advertising Service Provider System such as ad server 311 may be used for selecting an appropriate advertisement to be shown to user 308 along with the content provided by web server 303. According to different embodiments, ad server 311 may be configured as a single component or a plurality of separate components running at a single location or at one or more remote locations. Using browser 305, user 308 requests a web page from web server 303. Web server 303 may generate and send an ad request to ad server 311. The ad request may include a request for ad server 311 to provide an ad for placement with or alongside the content being provided to browser 305. As described in more detail below, ad server 311 makes a determination as to which ad network(s) 312 the ad should be requested from. Additional parameters may form part of the ad request, so that the selected ad network(s) 312 may each identify and provide one or more appropriate ad candidates based on context, user 308 characteristics, and/or other factors. According to different embodiments, the ad server 311 may obtains such information from data storage 304 and/or from one or more remote servers.

In at least one embodiment, the ad server 311 may send out one or more ad solicitation requests (herein referred to as “calls” or “hops”) to one or more ad network(s) 312 in order to solicit and select (from the various solicited ad networks) the most preferred ad for filling the ad request.

In one embodiment, the ad network 312 associated with the selected ad transmits the ad (or an identification of the ad) to ad server 311, and ad server obtains the ad and transmits it to browser 305 for display to user 308. In another embodiment, ad server 311 transmits the ad to web server 303, which integrates the ad with requested content and sends the integrated content to browser 305. In yet another embodiment, ad network 312 transmits the ad to browser 305 without relaying it through ad server 311. Whichever mechanism is used, the selected ad is displayed at output device 307 alongside requested content from web server 303.

The publisher of content at web server 303 can be compensated for the ad placement based on the relative effectiveness of the ad. Accordingly, it is advantageous for the ad selection process to yield ads that are more likely to be effective for a given user 308. In at least one embodiment, ad server 311 may be configured or designed to make an optimal selection among ad networks 312 so as to more effectively deliver ads that are of higher value.

FIG. 3B is a block diagram illustrating data flow for an embodiment for implementing various aspects of the online advertising techniques disclosed herein, including further details concerning the functional components of ad server(s) 311. For illustrative purposes, ad server 311 is depicted as a single entity; however, one skilled in the art will recognize that multiple ad servers 311 can be provided, each performing according to the techniques described herein.

In one embodiment, ad server 311 includes ad network selector 326, which may be implemented as software running on a processor at server 311 or on a different processor. Ad network selector 326 takes into account various factors in determining which ad network 312 to select for a particular website or content page being presented. Non-limiting examples of such factors may include, but are not limited to, one or more of the following (or combinations thereof):
site/page look and feel 321 (including cascading style sheets (CSS), colors, themes, and the like): this information can also be used for customizing the layout of the ad and for selection of ad colors, in order to maximize the click-through ratio (CTR);
geographic location 322 of user 308: this information is used for geographic targeting of advertisements;
subject matter or category 323 (also referred to as the “vertical”) of the site/page (such as gaming, technology, entertainment, news, etc.);
user data 325, such as may be retrieved from a UII File stored at client machine 301; and
contextual data 324, such as keywords on the content page: this information can be used for setting a bid price for advertisements;
etc.

In one embodiment, in selecting an ad network 312, ad network selector 326 takes into account ad network data 327 such as pricing data (or e-CPM), frequency, and the like. For example, ad network selector 326 can extract ad network pricing data from data 327. In one embodiment, ad network selector 326 makes use of data mining process 330 to extract relevant data. Data mining process 330 sends data to machine learning server 329 to analyze data for trends, and to revise prediction models based on new user and network data. Machine learning server 329 thereby generates decision parameters for use by ad network selector 326, and transmits such updated decision parameters to ad network selector 326 to communicate changes in the prediction model. In one embodiment, data mining and machine learning can take place off-line, using data from ad server 311. The results of these processes can be stored in a database (not shown) for later use by ad network selector 326. Machine learning server 329 and data mining process 330 can be implemented as part of ad server 311, or as separate components.

Admin user interface 328 is provided, to allow administrator 331 to view data, to manage and control the operation of selector 326 and other components of ad server 311, to make any manual overrides to the algorithms or processes, and/or to set any specific parameters.

Once ad server 311 has selected an ad network 312, in one embodiment it obtains the ad-code to be presented, and transmits the ad-code to web server 303. Client machine 301 retrieves the ad-code along with the content of the web page and then integrates the ad-code with the requested content. The ad-code then retrieves the actual ad content (such as images, video, and/or text) directly from the ad network 312 for presentation to user 308 via output device 307.

### Intelligent Impression Throttling

In many situations, online publishers use several different ad networks and/or exchanges for their online advertising needs. Existing techniques for selecting advertisements often fail to perform effective comparisons among multiple ad networks and/or exchanges. Without comparisons among multiple ad networks, existing techniques fail to provide Internet publishers with sufficient information to most effectively monetize their inventory. In addition, existing techniques often fail to provide online publishers with sufficiently detailed information concerning the effects of various factors that can affect the money that they earn. Such factors may include, for example, user frequency, geography, context/vertical, rate of ads that are defaulting to another network, demographic data, and the like.

Many of today's currently existing ad servers are configured to service ad requests on a first-come, first serve basis, and are typically configured to allocate whatever resources are available at the ad server to attempt to monetize each incoming impression that is received at the ad server. However, at various different times, and depending upon the specific conditions and parameters associated with each incoming impression, a given ad server may observe relatively high or low percentages of timeouts when servicing different ad requests. For example, some impressions may have relatively high fill rates while others may have relatively low fill rates.

According to different embodiments. the relative success (or lack of success) of filling a given incoming impression may depend upon a variety of different factors, conditions, and/or parameters associated with the incoming impression, particularly those which are used in bidding by the demand partners or advertisers. Examples of such factors, conditions, and/or parameters may include, but are not limited to, one or more of the following (or combinations thereof):
User demographics (audience segment)—Demographics of the end user who will be viewing the impression such as, for example, one or more of the following (or combinations thereof):
   Gender,
   Age,
   Ethnicity,
   Income classification
   Interests
   User ID
Location information relating to where the impression will be displayed, such as, for example, one or more of the following (or combinations thereof):
   Country,
   State,
   Province,
   City,
   GPS coordinates,
   Zip code,
   Region
   DMA (designated market area—e.g., for US markets)
Technical parameters associated with the device that will be displaying the impression such as, for example, one or more of the following (or combinations thereof):
   Device make/model,
   Operating system type,
   Device display screen size,
   Display screen resolution,
   Browser type,
   Smartphone model/type,
   Screen resolution
Time-related parameters, such as, for example, one or more of the following (or combinations thereof):
   Hour of Day,
   Date,
   Day of the week,
   Month,
Geolocation of the end user;
Website Site ID;
Webpage ID;
Publisher ID;
Ad size (e.g., size of ad to be displayed at end user device);
Historical bid values;
Historical click thru rates;
Historical conversions;
Cost per action;
Context of the publisher page where ad will be displayed;
Volume of impressions filled for end user (e.g., is the ad server handling sufficient number of impressions for the end user to enable the ad server to successfully predict (with relative certainty) which impressions are likely to be filled or go unfilled for that end user?);
Etc.

### Discrimination of Impressions

As described in greater detail herein, various aspects are disclosed for enabling an Advertising Service Provider System (e.g., which includes one or more ad servers) to improve profitability by selectively and dynamically discriminating between the various ad server resources which are to be allocated towards servicing different incoming impressions. Additional aspects are disclosed herein for enabling an ad server to dynamically evaluate the parameters of each incoming impressions in order to assess the likelihood of that incoming impression being successfully filled by demand partners and/or advertising networks. At various times when conditions warrant, the ad server may selectively and dynamically choose to throttle or drop the servicing of selected incoming ad requests/impressions in order to minimize losses which may occur as a result of servicing ad requests/impressions which result in defaults.

For example, in one embodiment, ad server may be configured or designed to analyze incoming impressions, and dynamically classify (e.g., in real-time) one or more of the incoming impressions as being either a “favored impression” (e.g., an impression which is deemed to have a relatively high likelihood of being filled by the demand partners/advertising networks) or a “non-favored impression” (e.g., an impression which is deemed to have a relatively low likelihood of being filled by the demand partners/advertising networks). In at least some embodiments, the ad server may use the dynamically generated impression classification information discriminate between the resources allocated to incoming impressions. For example, in at least one embodiment, the ad server may reduce (or even drop) the resources allocated to selected incoming impressions which the ad server has identified as having a relatively low likelihood of being filled (e.g., low fill rate). This may be referred to as “impression throttling.” Alternatively, the ad server may allocate its normal amount of resources (and/or may increase allocation of resources) to selected incoming impressions which the ad server has identified as having a relatively high likelihood of being filled (e.g., high fill rate).

According to different embodiments, the ad server may be configured or designed to implement such resource discrimination at times when specifically defined condition(s) and/or event(s) have been detected, such as, for example, at predefined time intervals, at times when the occurrence of ad request timeouts are relatively high (e.g., above 10%), and/or upon the detection of other specified event(s) and/or condition(s) such as, for example, one or more of the following (or combinations thereof):
Event(s) relating to one or more publisher(s) reporting timeouts at their end in excess of some threshold criteria;
Detection of ad server traffic nearing traffic limit threshold criteria. For example, if the threshold criteria specifies that the ad server traffic limit is 300 requests per second, Impression Throttling may be automatically triggered upon detecting that the ad server traffic has reached (or exceeded) 280 requests per second.
and/or other types of event(s) and/or condition(s) such as those described and/or referenced herein.

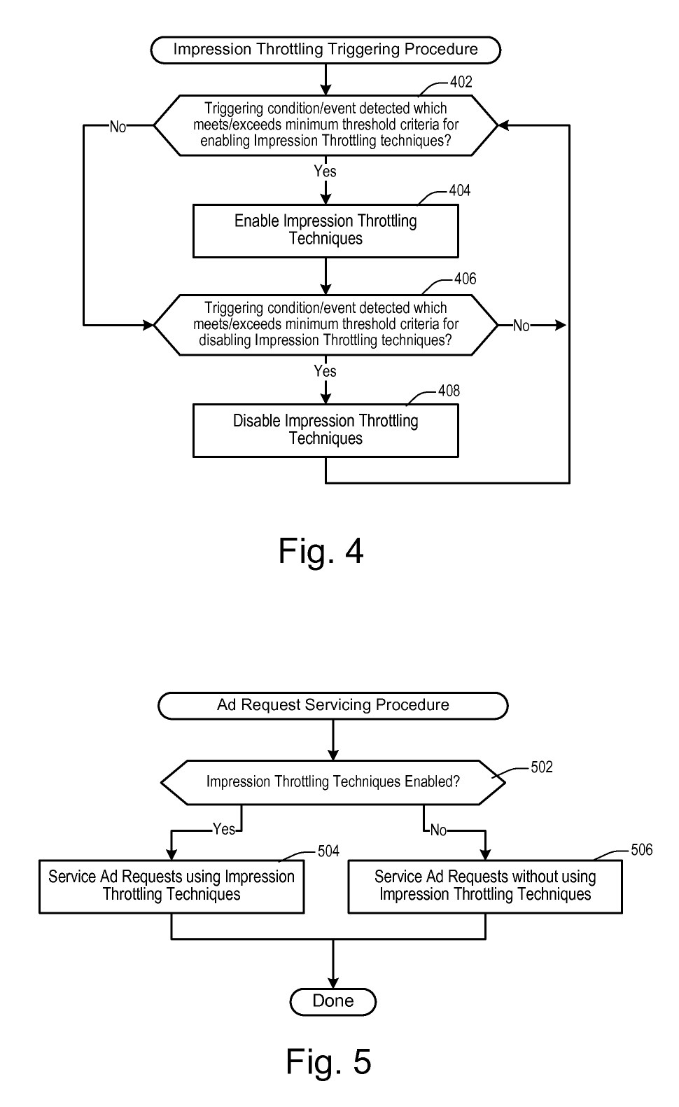

FIGS. 4-7 show various flow diagrams of different Impression Throttling-related procedures in accordance with specific embodiments. According to different embodiments, at least a portion of the various types of functions, operations, actions, and/or other features provided by one or more of the Impression Throttling-related procedures of FIGS. 4-7 may be implemented at one or more one or more server system(s) such as, for example, Advertising Service Provider System (120, FIG. 1), ad server (311) and/or combinations thereof.

In at least one embodiment, one or more of the Impression Throttling-related procedures may be operable to perform and/or implement various types of ad serving functions, operations, actions, and/or other features such as one or more of those described and/or referenced herein. One or more of the Impression Throttling-related procedures may also be operable to utilize and/or generate various different types of data and/or other types of information when performing specific tasks and/or operations. This may include, for example, input data/information and/or output data/information. For example, in at least one embodiment, one or more of the Impression Throttling-related procedures may be operable to access, process, and/or otherwise utilize information from one or more different types of sources, such as, for example, one or more local and/or remote memories, devices and/or systems. Additionally, in at least one embodiment, one or more of the Impression Throttling-related procedures may be operable to generate one or more different types of output data/information, which, for example, may be stored in memory of one or more local and/or remote devices and/or systems. Examples of different types of input data/information and/or output data/information which may be accessed and/or utilized by one or more of the Impression Throttling-related procedures may include, but are not limited to, one or more of those described and/or referenced herein.

In at least one embodiment, a given instance of at least one of the Impression Throttling-related procedures may access and/or utilize information from one or more associated databases. At least a portion of the database information may be accessed via communication with one or more local and/or remote memory devices. Examples of different types of data which may be accessed by one or more of the Impression Throttling-related procedures may include, but are not limited to, one or more of those described and/or referenced herein.

According to specific embodiments, multiple instances or threads of one or more of the Impression Throttling-related procedures may be concurrently implemented and/or initiated via the use of one or more processors and/or other combinations of hardware and/or hardware and software. For example, in at least some embodiments, various aspects, features, and/or functionalities of one or more of the Impression Throttling-related procedures may be performed, implemented and/or initiated by one or more of the various systems, components, systems, devices, procedures, processes, etc., described and/or referenced herein. According to different embodiments, one or more different threads or instances of the Impression Throttling-related procedures may be initiated in response to detection of one or more conditions or events satisfying one or more different types of minimum threshold criteria for triggering initiation of at least one instance of one or more of the Impression Throttling-related procedures. Various examples of conditions or events which may trigger initiation and/or implementation of one or more different threads or instances of the Impression Throttling-related procedures may include, but are not limited to, one or more of those described and/or referenced herein. According to different embodiments, one or more different threads or instances of the Impression Throttling-related procedures may be initiated and/or implemented manually, automatically, statically, dynamically, concurrently, and/or combinations thereof. Additionally, different instances and/or embodiments of one or more of the Impression Throttling-related procedures may be initiated at one or more different time intervals (e.g., during a specific time interval, at regular periodic intervals, at irregular periodic intervals, upon demand, etc.).

In at least one embodiment, initial configuration of a given instance of at least one of the Impression Throttling-related procedures may be performed using one or more different types of initialization parameters. In at least one embodiment, at least a portion of the initialization parameters may be accessed via communication with one or more local and/or remote memory devices. In at least one embodiment, at least a portion of the initialization parameters provided to an instance of one or more of the Impression Throttling-related procedures may correspond to and/or may be derived from the input data/information.

For purposes of illustration, it is assumed that instances of one or more of the Impression Throttling-related procedures are running at an ad server of the Advertising Service Provider System (e.g., 120, FIG. 1).

FIG. 4 shows an example flow diagram of an Impression Throttling Triggering Procedure in accordance with a specific embodiment. In at least one embodiment, the Impression Throttling Triggering Procedure may be configured or designed to enable or disable use of Impression Throttling techniques at the ad server in response to detecting various event(s) and/or condition(s). For example, as shown in the example embodiment of FIG. 4, at 402, the ad server may continuously and/or periodically monitor for detection of one or more triggering condition(s)/event(s) which meets/exceeds minimum threshold criteria for enabling use of Impression Throttling techniques at the ad server. If one or more triggering condition(s)/event(s) is detected which meets/exceeds minimum threshold criteria for enabling use of Impression Throttling techniques, then Impression Throttling techniques may be enabled (404) at the ad server.

Similarly, as shown in the example embodiment of FIG. 4, at 406 ad server may continuously and/or periodically monitor for detection of one or more triggering condition(s)/event(s) which meets/exceeds minimum threshold criteria for disabling use of Impression Throttling techniques at the ad server. If one or more triggering condition(s)/event(s) is detected which meets/exceeds minimum threshold criteria for disabling use of Impression Throttling techniques, then Impression Throttling techniques may be disabled (408) at the ad server.

Non-limiting examples of various triggering condition(s)/event(s) which may meet/exceed minimum threshold criteria for enabling and/or disabling use of Impression Throttling techniques may include, but are not limited to, one or more of the following (or combinations thereof):
Time-based criteria such as, for example, predefined time intervals, peak hours, specific minutes of each hour, specific hours of the day, specific days of the week, etc.
Timeout-based criteria, such as, for example, during times when it is determined that the occurrence of ad request timeouts during a given time period meets or exceeds a specified threshold timeout percentage value (e.g., when at least 10% of the incoming ad requests to the ad server result in a timeout or result in the ad server responding with a default).
Detection of event(s) relating to one or more publisher(s) reporting timeouts at their end in excess of some threshold criteria;
Detection of ad server traffic nearing traffic limit threshold criteria;
And/or upon the detection of other specified event(s) and/or condition(s) such as one or more of those described and/or referenced herein.

In some embodiments, the ad server may disable throttling for a specified percentage of the total traffic. This enables the ad server to dynamically learn the changes in the DSPs' priorities, and helps the ad server to dynamically retune the Impression Throttling-related procedures and/or algorithms. By way of illustration, in some embodiments, the ad server may enable user of Impression Throttling techniques in one or more of the following ways (or combinations thereof):
Toggle use of throttling algorithms (for servicing of incoming ad requests) every n minutes. For example, in one embodiment, Impression Throttling may be enabled for one minute, then disabled for the next minute, then enabled for the next minute, then disabled for the next minute, etc.
Impression Throttling may be enabled (or disabled) for a fixed amount of ad servers (e.g., Impression Throttling enabled for 20% of the ad servers of the Advertising Service Provider System).
The ad server may enable use of Impression Throttling for incoming impressions associated with one or more specified publisher(s).
The ad server may enable use of Impression Throttling during times when it is detected that the ad server's available resources are below a minimum specified threshold value (e.g., during times when it is detected that the ad server's currently available resources are less than 50% of the ad server's total resources).
The ad server may enable use of Impression Throttling during times when it is detected that the ad server's resource usage is above a maximum specified threshold value (e.g., during times when it is detected that the ad server's current resource usage is over 60% of the ad server's total resources).

In some embodiments, use of Impression Throttling may be dynamically controlled using Cache Pushback techniques, which, for example, enables immediate control of ad server settings at runtime.

In some embodiments, an ad server may be configured or designed to operate in different modes of Impression Throttling such as, for example, one or more of the following (or combinations thereof):
Throttling Off Mode (e.g., default mode)—Impression Throttling not enabled for servicing of incoming ad requests.
Throttling On Mode—Impression Throttling not enabled for servicing of incoming ad requests.
Strict Throttling Mode—Incoming impressions which are determined to be non-favored impressions (e.g., impressions which the ad server has determined to have relatively low likelihoods of being filled by the demand partners/advertising networks) may be allocated only limited resources for filling the associated impression(s). For example, in one embodiment, while in Active Throttling Mode, the ad server may implement Impression Throttling for a non-favored incoming impression by allocating only limited resources for RTB, and by limiting Adnet/S2S network calls to a single hop.
Lenient Throttling Mode—Impression Throttling techniques may be periodically enabled for a first specified time period, and may be periodically disabled for a specified second time period. For example, in one embodiment, while in Lenient Throttling Mode, the ad server may apply Strict Impression Throttling procedures every alternate minute.

By way of example, in one embodiment, the ad server may first start off operating in Lenient Throttling Mode to test current conditions, analyze the results, and then dynamically change the Impression Throttling operating mode based on the analyzed results. The timeout percentages and fill-rates for incoming impressions may be tracked (e.g., in real-time) on a periodic basis (e.g., hourly basis). The tracked information may be periodically analyzed by the ad server along with relevant tracked information which is shared by the Publisher. The analyzed information may then be used by the ad server to periodically determine whether the currently implemented Impression Throttling techniques/procedures should be dynamically changed or modified. For example, in one embodiment, the ad server may start off operating in Lenient Throttling Mode, may monitor and analyze the results for about 30 minutes, and then determine whether the currently implemented Impression Throttling techniques/procedures should be dynamically changed or modified.

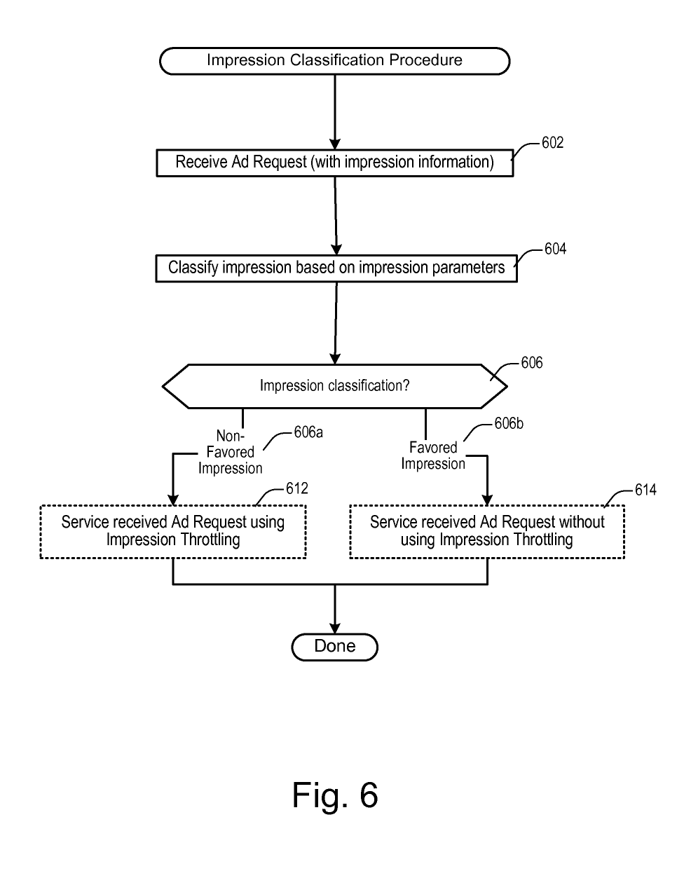

FIG. 5 shows an example flow diagram of an Ad Request Servicing Procedure in accordance with a specific embodiment. In the specific example embodiment of FIG. 5, the ad server may continuously and/or periodically determine whether or not the use of Impression Throttling techniques is currently enabled or allowed. If it is determined that Impression Throttling techniques are enabled, the ad server may service (504) incoming Ad Requests using Impression Throttling techniques. If it is determined that Impression Throttling techniques not are enabled, the ad server may service (506) incoming Ad Requests without using Impression Throttling techniques.

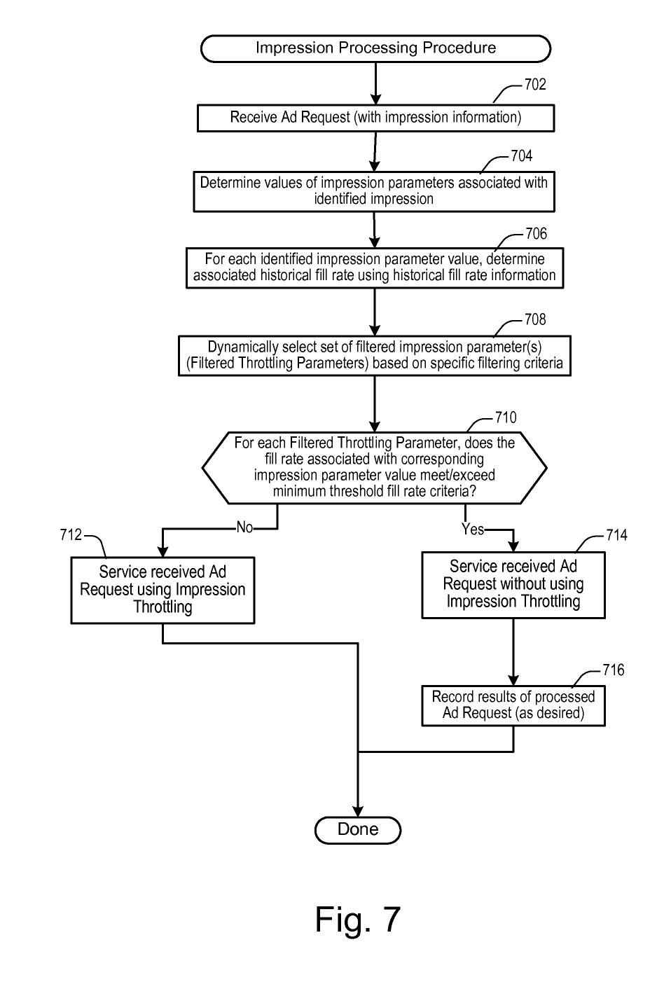

FIG. 6 shows an example flow diagram of an Impression Classification Procedure in accordance with a specific embodiment. As described above, the ad server may be configured or designed to analyze incoming impressions, and dynamically classify (e.g., in real-time) one or more of the incoming impressions as being either a “favored impression” (e.g., an impression which is deemed to have a relatively high likelihood of being filled by the demand partners/advertising networks) or a “non-favored impression” (e.g., an impression which is deemed to have a relatively low likelihood of being filled by the demand partners/advertising networks). Assuming that Impression Throttling is enabled, the ad server may then use the dynamically generated impression classification information discriminate between the resources allocated to incoming impressions.

By way of example, it is assumed at 602 that an incoming ad request is received at the ad server. According to different embodiments, the ad request may include various types of information about an identified impression and associated web page such as, for example, one or more of the following (or combinations thereof): URL, demographic info relating to the end user (who will be viewing the ad), geolocation of end user, information relating to the end user's device (e.g., phone model), user data, publisher information, and/or other parameters such as one or more of those described and/or referenced herein. The received ad request may be processed at the ad server, and may be supplemented with additional information retrieved from one or more local and/or remote database(s). Non-limiting examples of such additional information may include, but are not limited to, one or more of the following (or combinations thereof):
Demographics of the end user who will be viewing the impression such as, for example, one or more of the following (or combinations thereof): Gender; Age; Ethnicity; Income classification; Interests; User ID; etc.;
Location information relating to where the impression will be displayed, such as, for example, one or more of the following (or combinations thereof): Country; State; Province; City; GPS coordinates; Zip code; Region; DMA (designated market area); etc.;
Technical parameters associated with the device that will be displaying the impression such as, for example, one or more of the following (or combinations thereof): Device make/model; Operating system type; Device display screen size; Display screen resolution; Browser type; Smartphone model/type; Screen resolution; etc.;
Time-related parameters, such as, for example, one or more of the following (or combinations thereof): Hour of Day; Date; Day of the week; Month; etc.;
Other types of relevant and/or related information such as, for example, one or more of the following (or combinations thereof): Geolocation of the end user; Website Site ID; Webpage ID; Publisher ID; Ad size (e.g., size of ad to be displayed at end user device); Historical bid values; Historical click thru rates; Historical conversions; Cost per action; Context of the publisher page where ad will be displayed; etc.

In the specific example embodiment of FIG. 6, it is assumed that Impression Throttling is currently enabled at the ad server. Accordingly, in this particular example, as shown at 604, the ad server may classify the identified impression based on one or more impression parameters relating to the identified impression. For example, the ad server may dynamically classify the identified impression as a “favored impression” (606b) (e.g., if the ad server determines that the identified impression has a relatively high likelihood of being filled by the demand partners/advertising networks) or as a “non-favored impression” (606a) (e.g., if the ad server determines that the identified impression has a relatively low likelihood of being filled by the demand partners/advertising networks).

In at least one embodiment, the classifying of an identified impression as either a favored impression or non-favored impression may be accomplished, at least in part, using historical data relating to previously processed ad requests. For example, by analyzing historical impression parameter data and associated fill-rate information relating to previously processed ad requests and impressions, it is possible to detect and/or identify patterns and correlations between specific impression parameters and associated historical fill-rates.

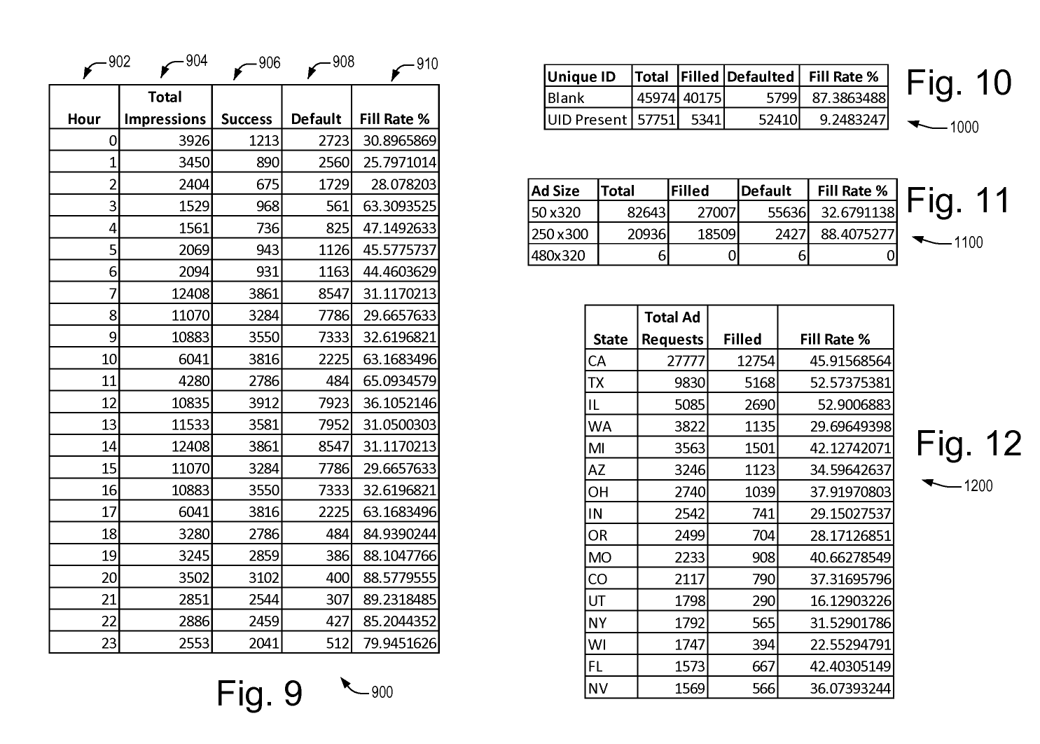

For example, FIG. 8 shows a sample data table 800 which has been populated with sample historical data relating to the processing of prior incoming impressions which, for example, were processed at one or more of the ad servers of the Advertising Service Provider System. In the example embodiment of FIG. 8, each record (e.g., 801, 803) of the table 800 may be populated with historical data relating to a respectively different impression which was processed at a given ad server. As illustrated in the specific example of FIG. 8, the recorded historical data may include data relating to one or more of the following impression parameters (or combinations thereof):
Response type parameter (802) or response outcome representing the final response or outcome (e.g., default or filled) associated with the processing of a specific impression.
Ad display size parameters (e.g., height parameter 804, width parameter 806) associated with the identified impression.
Hour of day parameter (806) identifying a specific hour of the day when the impression was processed.
Unique ID parameter (808) identifying a unique identifier associated with the end user who will be viewing the ad/impression. In some embodiments this field may be left blank if no unique identifier was known at the time of processing of the impression.
Latitude parameter (810) identifying the latitude component associated with the geolocation of the end user's device at the time of processing the impression;
Longitude parameter (812) identifying the longitude component associated with the geolocation of the end user's device at the time of processing the impression.
Country parameter (814) identifying the country where the ad will be displayed.
State parameter (816) identifying the state where the ad will be displayed.
City parameter (818) identifying the city where the ad will be displayed
Marketing District parameter (DMA) (820) identifying the marketing district where the ad will be displayed;
ZIP Code parameter (822) identifying the ZIP Code where the ad will be displayed;
and/or other types of impression parameters described and/or referenced herein.

In at least one embodiment, the recorded historical impression parameter data may be aggregated and analyzed for detection and/or identification of patterns and correlations between specific impression parameters and historical fill-rates. For example, in some embodiments, different historical fill rate values may be computed for one or more identified impression parameters across a range of values for each identified impression parameter. Various examples of this are described with respect to FIGS. 9-12.

FIG. 9 shows a sample data table 900 which has been populated with sample historical data relating to the processing of prior incoming impressions having different values for the “Hour of Day” impression parameter. For example, as illustrated in the example table 900, the historical data indicates (in part) that:
During hour 3 (which, for example, may correspond to the time period of 3:00 am-3:59 am GMT), a total of 1,529 incoming impressions (904) were received and processed at the ad server (or at one or more ad servers of the Advertising Service Provider System); 968 of the processed impressions during hour 3 were successfully filled (906); and 561 of the processed impressions during hour 3 resulted in default (e.g., impression not filled) (908). The calculated historical Fill Rate of impressions processed during hour 3 (e.g., as expressed as a percentage of: (total impressions successfully filled)/(total impressions processed)), indicates that about 63.3% of the impressions processed during hour 3 were successfully filled.
During hour 8 (which, for example, may correspond to the time period of 8:00 am-8:59 am GMT), a total of 11,070 incoming impressions were received and processed at the ad server (or at one or more ad servers of the Advertising Service Provider System); 3,284 of the processed impressions during hour 8 were successfully filled; and 7,786 of the processed impressions during hour 8 resulted in default (e.g., impression not filled). The calculated historical Fill Rate (910) of impressions processed during hour 8 indicates that about 29.7% of the impressions processed during hour 8 were successfully filled.
During hour 20 (which, for example, may correspond to the time period of 20:00-20:59 GMT), a total of 3,502 incoming impressions were received and processed at the ad server (or at one or more ad servers of the Advertising Service Provider System); 3,102 of the processed impressions during hour 20 were successfully filled; and 400 of the processed impressions during hour 20 resulted in default (e.g., impression not filled). The calculated historical Fill Rate of impressions processed during hour 20 indicates that about 88.6% of the impressions processed during hour 20 were successfully filled.
Etc.

FIG. 10 shows a sample data table 1000 which has been populated with sample historical data relating to the processing of prior incoming impressions having different values for the “Unique ID” (or UID) impression parameter. For example, as illustrated in the example table 1000, the historical data indicates that:
A total of 45,974 incoming impressions which were not associated with any UID were received and processed (e.g., during a specified time interval); 40175 of these processed impressions were successfully filled; and 5799 of these processed impressions resulted in default. The calculated historical Fill Rate data indicates that about 87.4% of the incoming impressions no UID data were successfully filled.
A total of 57751 incoming impressions with UID data were received and processed (e.g., during a specified time interval); 5341 of these processed impressions were successfully filled; and 52410 of these processed impressions resulted in default. The calculated historical Fill Rate data indicates that about 9.3% of the incoming impressions with UID data were successfully filled.

FIG. 11 shows a sample data table 1100 which has been populated with sample historical data relating to the processing of prior incoming impressions having different values for the “Ad Size” impression parameter. For example, as illustrated in the example table 1100, the historical data indicates that:
For incoming impressions associated with an ad size of 50×320, a total of 11,070 incoming impressions were received and processed; 3,284 of these processed impressions were successfully filled; and 7,786 of these processed impressions resulted in default (e.g., impression not filled). The calculated historical Fill Rate data indicates that about 9.3% of the incoming impressions associated with an ad size of 50×320 were successfully filled.
For incoming impressions associated with an ad size of 250×300, a total of 20936 incoming impressions were received and processed; 18509 of these processed impressions were successfully filled; and 2427 of these processed impressions resulted in default (e.g., impression not filled). The calculated historical Fill Rate data indicates that about 88.4% of the incoming impressions associated with an ad size of 250×300 were successfully filled.
For incoming impressions associated with an ad size of 480×320, a total of 6 incoming impressions were received and processed; 0 of these processed impressions were successfully filled; and 6 of these processed impressions resulted in default (e.g., impression not filled). The calculated historical Fill Rate data indicates that 0% of the incoming impressions associated with an ad size of 480×320 were successfully filled.

FIG. 12 shows a sample data table 1200 which has been populated with sample historical data relating to the processing of prior incoming impressions having different values for the “State” impression parameter. For example, as illustrated in the example table 12, the historical data indicates (in part) that:
For incoming impressions identifying CA for the State impression parameter (e.g., where the impression will be displayed, or where the end user is located), a total of 27777 incoming impressions were received and processed; 12754 of these processed impressions were successfully filled. The calculated historical Fill Rate data indicates that about 45.9% of the incoming impressions specifying CA for the State impression parameter were successfully filled.
For incoming impressions identifying TX for the State impression parameter (e.g., where the impression will be displayed, or where the end user is located), a total of 9830 incoming impressions were received and processed; 5168 of these processed impressions were successfully filled. The calculated historical Fill Rate data indicates that about 52.6% of the incoming impressions specifying TX for the State impression parameter were successfully filled.
For incoming impressions identifying WA for the State impression parameter (e.g., where the impression will be displayed, or where the end user is located), a total of 3822 incoming impressions were received and processed; 1135 of these processed impressions were successfully filled. The calculated historical Fill Rate data indicates that about 29.7% of the incoming impressions specifying WA for the State impression parameter were successfully filled.
Etc.

In at least one embodiment, the ad server may generate, populate, and store a plurality of different historical fill rate data tables such as those illustrated in FIGS. 8-12. For example, in one embodiment, the ad server may generate, populate, and store (e.g., at one or more local databases) a separate historical fill rate data table for each (or selected) respective impression parameter which may be used in bidding by various demand partners/advertising networks. Further, in at least some embodiments, the ad server (and/or other components of the Advertising Service Provider System) may periodically and/or asynchronously update the data in the various historical fill rate data tables with additional information relating to recently processed ad requests/impressions. However, in at least some embodiments, it is preferable to exclude from such historical fill rate data tables any data relating to the processing of throttled ad requests/impressions.

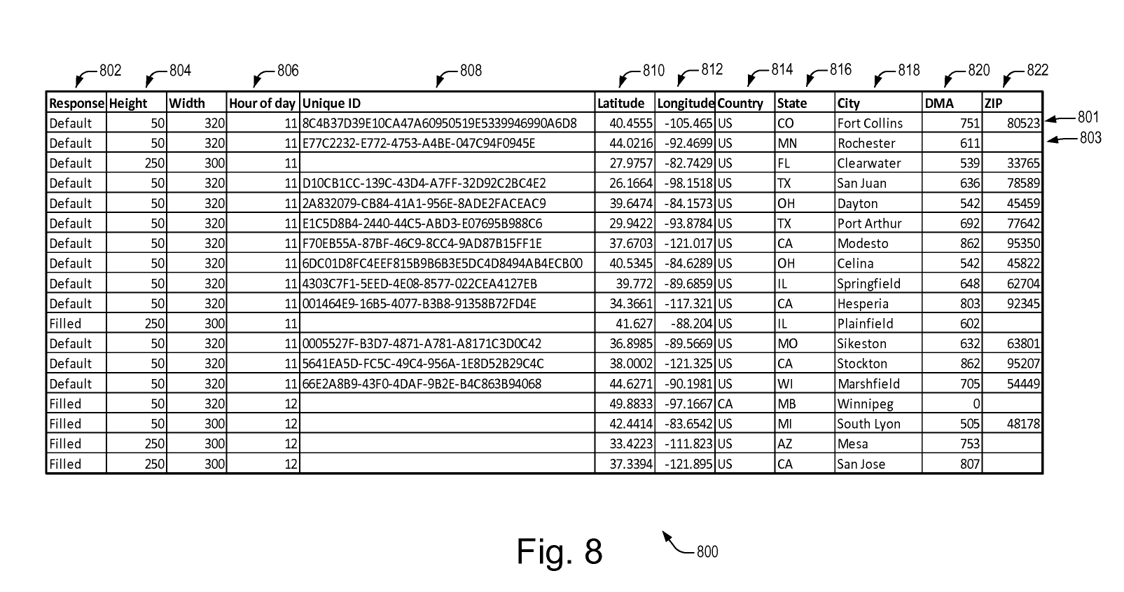

As noted in the examples above, different historical fill rate values may be computed for one or more identified impression parameters across a range of values for each identified impression parameter. By using such historical impression parameter data and associated historical fill rate information, an ad server (and/or other components of the Advertising Service Provider System) may be able to identify the value(s) associated with one or more specific impression parameter(s) of an identified incoming impression, and use at least one of the identified impression parameter value(s) to estimate or predict the likelihood of successfully filling the identified incoming impression. Additional aspects and details relating to these concepts are further described herein with respect to FIG. 7. In at least one embodiment, when determining the likelihood of successfully filling the identified incoming impression, the ad server may also take into account an imposed time constraints, such as, for example, being able to provide fill the identified impression and a response to the ad request within a specified response time period (e.g., within an amount of time which does not exceed a response timeout latency value such as, for example, 500 ms).

Returning to FIG. 6, in at least one embodiment the ad server may be configured or designed to facilitate, enable, initiate, and/or perform one or more of the following operation(s), action(s), and/or feature(s) (or combinations thereof):
Identify the value of at least one specified impression parameter associated with the identified impression.
Access historical fill rate data relating to the identified value of the at least one specified impression parameter.
Determine the historical aggregate fill rate of previously processed impressions having an impression parameter value which matches the identified value of at least one specified impression parameter associated with the identified impression.
Classify the identified impression as a “favored impression” if it is determined that the determined historical fill rate meets or exceeds a first set of predetermined threshold criteria.
Classify the identified impression as a “non-favored impression” if it is determined that the determined historical fill rate does not meet the first set of predetermined threshold criteria.
Process (614) the identified impression without using Impression Throttling procedures if it is determined that the identified impression may be classified as a “favored impression”.
Process (612) the identified impression using Impression Throttling procedures if it is determined that the identified impression may be classified as a “non-favored impression”.

For example, in one example embodiment, the ad server may determine that an incoming impression includes a “State” impression parameter which specifies a value of “TX” corresponding to the state of Texas. Using this information, the ad server may access the historical impression data from table 1200 (FIG. 12) to determine the historical fill rate of previously processed impressions which specified TX for the “State” impression parameter. As illustrated in the example historical data table 1200, the calculated historical Fill Rate value for impressions specifying TX for the State impression parameter is about 52.57%. Using this historical fill rate value (52.57%), the ad server may classify the identified impression as a “favored impression” if it is determined that the identified historical fill rate value (52.57%) meets or exceeds a first set of predetermined threshold criteria. Alternatively, the ad server may classify the identified impression as a “non-favored impression” if it is determined that the identified historical fill rate value (52.57%) does not meet or exceed the first set of predetermined threshold criteria.

For example, in one embodiment, while operating in Strict Throttling Mode, the identified impression may be determined to be a “favored impression” if it is determined that the identified historical fill rate value is greater than or equal to a first threshold value such as, for example, 70%. If the ad server determines that the identified historical fill rate value is less than the first threshold value (70%), the ad server may classify the identified impression as a “non-favored impression.” In this particular example, the ad server may classify the impression as a non-favored impression since the identified historical fill rate value of 52.57% is less than the “favored impression” threshold criteria value of 70%.

In another example embodiment, while operating in Lenient Throttling Mode, the identified impression may be determined to be a “favored impression” if it is determined that the identified historical fill rate value is greater than or equal to a second threshold value (e.g., 50%). If the ad server determines that the identified historical fill rate value is less than the second threshold value (50%), the ad server may classify the identified impression as a “non-favored impression.” In this particular example, the ad server may classify the impression as a favored impression since the identified historical fill rate value of 52.57% is greater than the “favored impression” threshold criteria value of 50%.

In at least some embodiments, alternative techniques may be employed for classifying the identified impression as either a “favored impression” or a “non-favored impression.” For example, in at least one embodiment, a RTB Price Prediction (RPP) technique may be used by the ad server for classifying the identified impression as either a “favored impression” or a “non-favored impression.” In one embodiment, the RTB Price Prediction (RPP) technique may be implemented as a module running at the ad server which is configured or designed to predict the e-CPM that the ad server may attain from RTB auctions for a given impression, based on the impression parameters and attributes.

As illustrated in the example embodiment of FIG. 6, if the ad server determines that the identified impression may be classified as a “favored impression” (606b), then the ad server may service (614) the received ad request without using Impression Throttling. For example, according to different embodiments, the ad server may allocate its standard or full resources for servicing the ad request such as, for example, some or all of the following:

performing RTB auction;

performing one or more Adnet/S2S network auctions;

performing one or more ad campaign auctions;

performing one or more guaranteed fill auctions;

allocating full timeouts (e.g., 140 ms) for RTB calls;

allocating full timeouts (e.g., 200 ms) for Adnet/S2S network calls;

allowing multiple hops for Adnet/S2S networks;

In at least one embodiment, the full servicing of an ad request (e.g., without implementing Impression Throttling) may include sending out one or more consecutive sets of parallel calls to selected sets or groups of advertiser(s)/Ad Network(s). For example, the ad server may send out a first set of calls (e.g., ad solicitation requests) to a first selected set of advertiser(s)/Ad Network(s). If none of the received bids/responses from the first set of advertiser(s)/Ad Network(s) is higher than the e-CPM value of highest bidding Mobile Ad Network (herein referred to as Mobile Display Networks (“Adnet”) or Server-to-Server Networks (“S2S”)), then one or more consecutive sets of parallel calls may be sent to selected sets or groups of Mobile Ad Networks, which, for example, may include Beacon Based Ad Networks (BBCs) and/or Non-Beacon Based Ad Networks (NBBCs). In one embodiment, if either the RTB or ad campaign has a relatively higher e-CPM than the highest paying Mobile Ad Network, the impression may be awarded to the RTB or ad campaign which has the relatively highest e-CPM value. If neither the RTBs nor ad campaigns have relatively higher e-CPM than the highest responding Mobile Ad Network, then, in one embodiment, the highest responding Mobile Ad Network may be awarded the impression. Alternatively, in some embodiments, if the ad server determines that there are additional Mobile Ad Networks that may pay higher than the response currently identified as paying the highest e-CPM, the ad server may choose to initiate and send additional set(s) of parallel calls to additional sets of Mobile Ad Networks, based on the amount of time which the ad server determines is available.

Alternatively, if the ad server determines that the identified impression may be classified as a “non-favored impression” (606a), then the ad server may service (612) the received ad request using one or more Impression Throttling techniques. For example, according to different embodiments, the ad server may dynamically throttle resources allocated for servicing the “non-favored impression” ad request by performing one or more of the following activities (or combinations thereof):
skip RTB auction;
skip Adnet/S2S network auction(s);
limit the number of S2S hops;
reduce the RTB timeout parameter (e.g., to 50 ms) to thereby reduce the amount of time spent in waiting for the DSPs to respond to the RTB calls;
skip calls to Adnet/S2S networks;
reduce the Adnet/S2S timeout parameter (e.g., to 80 ms) to thereby reduce the amount of time spent in waiting for the Adnet/S2S network(s) to respond to the Adnet/S2S network calls;
limit or reduce the number of Adnet/S2S network hops which can be performed (e.g., limit to 1 Adnet/S2S network hop);
drop the ad request;
etc.

It will be appreciated that in at least some embodiments, the classifying of the incoming impressions (e.g., as either favored or non-favored) may be omitted. In such embodiments, alternative triggering mechanisms and/or processes may be utilized by the ad server for causing and incoming impression to be processed using one or more Impression Throttling techniques. For example, in at least one embodiment, the ad server may be configured or designed to facilitate, enable, initiate, and/or perform one or more of the following operation(s), action(s), and/or feature(s) (or combinations thereof):
Process the identified impression without using Impression Throttling procedures if it is determined that an identified historical fill rate value meets or exceeds a first set of predetermined threshold criteria.
Process the identified impression using Impression Throttling procedures if it is determined that an identified historical fill rate does not meet the first set of predetermined threshold criteria.

Additional examples of such other Impression Throttling triggering mechanisms are described in greater detail below with respect to FIG. 7.

FIG. 7 shows an example flow diagram of an Impression Processing Procedure in accordance with a specific embodiment. According to different embodiments, one or more ad servers of the Advertising Service Provider System may be configured or designed to implement the Impression Processing Procedure of FIG. 7 during the processing and/or servicing of incoming ad requests/impressions. In at least one embodiment, the Impression Processing Procedure enables an ad server to selectively identify which incoming impressions to throttle or drop in order to maximize potential revenue by allocating more of its resources towards servicing Ad Request that have the relatively highest probability of being successfully filled, particularly during times when the ad server is experiencing relatively high numbers of ad request timeouts (e.g., timeouts in excess of 10% over a specific time interval).

In the specific example embodiment of FIG. 7, it is assumed that use of Impression Throttling techniques is currently enabled.

As shown at 702, it is assumed that an incoming ad request is received at the ad server. According to different embodiments, the ad request may include various types of information about an identified impression and associated web page such as, for example, one or more of the following (or combinations thereof): URL, demographic info relating to the end user (who will be viewing the ad), geolocation of end user, information relating to the end user's device (e.g., phone model), user data, publisher information, and/or other parameters such as one or more of those described and/or referenced herein. The received ad request may be processed at the ad server, and may be supplemented with additional information retrieved from one or more local and/or remote database(s). Non-limiting examples of such additional information may include, but are not limited to, one or more of the following (or combinations thereof):
Demographics of the end user who will be viewing the impression such as, for example, one or more of the following (or combinations thereof): Gender; Age; Ethnicity; Income classification; Interests; User ID; etc.;
Location information relating to where the impression will be displayed, such as, for example, one or more of the following (or combinations thereof): Country; State; Province; City; GPS coordinates; Zip code; Region; DMA (designated market area); etc.;
Technical parameters associated with the device that will be displaying the impression such as, for example, one or more of the following (or combinations thereof): Device make/model; Operating system type; Device display screen size; Display screen resolution; Browser type; Smartphone model/type; Screen resolution; etc.;
Time-related parameters, such as, for example, one or more of the following (or combinations thereof): Hour of Day; Date; Day of the week; Month; etc.;
Other types of relevant and/or related information such as, for example, one or more of the following (or combinations thereof): Geolocation of the end user; Website Site ID; Webpage ID; Publisher ID; Ad size (e.g., size of ad to be displayed at end user device); Historical bid values; Historical click thru rates; Historical conversions; Cost per action; Context of the publisher page where ad will be displayed; etc.

As shown at 704, the ad server may determine or identify the values of the impression parameters associated with the identified impression. In at least one embodiment, the identified impression parameter values may preferably impression parameters which are used in bidding by various demand partners/advertising networks.

By way of example, and for purposes of illustration, it is assumed that the received ad request includes information identifying an impression (Impression A) which includes the following impression parameter values:

Impression A Parameter Values
Hour of Day: 11
Day of Week: Tues
State: TX
City: Dallas
Country: USA
ZIP: 75209
Site ID: Site A
Ad Size: 250×300

As shown at 706, for each identified impression parameter value, the ad server may dynamically determine its associated historical fill rate value using historical fill rate information such as that illustrated, for example, in the historical data tables of FIGS. 8-12. In the present example, the ad server may use the Impression A Parameter Values (above) to determine each parameter's associated historical fill rate value using historical fill rate data, which, for example, may be stored at one or more local databases. For purposes of illustration, it is assumed that the ad server has dynamically determined the historical fill rate values in accordance with the example data indicated in Table 1 (below).

TABLE 1

| Impression | | Fill |
|---|---|---|
| Parameter | Value | Rate % |
| Hour of Day | 11 | 65 |
| Day of Week | Tues | 48 |
| State | TX | 53 |
| City | Dallas | 47 |
| Country | USA | 91 |
| ZIP | 75209 | 37 |
| Ad Size | 250 × 300 | 88 |
| User ID | User A | 9 |

As shown at 708, a filtered set of the impression parameters associated with the identified impression (herein referred to as “Filtered Throttling Parameters”) may be automatically and/or dynamically selected based on specific filtering criteria.

For example, in at least one embodiment, the filtered set of the impression parameters may be automatically and/or dynamically selected based on each parameter's associated fill rate dispersion indicator.

More specifically, each different impression parameter may have associated with it a corresponding fill rate dispersion indicator which is indicative of the “spread” (e.g., amount of variation or dispersion) of the distribution of historical fill rate values associated with that particular impression parameter. According to different embodiments, the fill rate dispersion indicator for a given impression parameter may be dynamically calculated (e.g., by the ad server or other component(s) of the Advertising Service Provider System) using different statistical methods.

For example, in some embodiments, the fill rate dispersion indicator for a given impression parameter (e.g., Hour of Day) may be determined by calculating the standard deviation of the set of historical fill rate values (e.g., 910, FIG. 9) which are associated with that impression parameter. Thus, for example, using the historical fill rate values (e.g., 910, FIG. 9) which are associated the Hour of Day parameter, the ad server may dynamically determine the fill rate dispersion indicator for the Hour of Day impression parameter to be about 23.48.

In other embodiments, the fill rate dispersion indicator for a given impression parameter may be determined by calculating the variance of the set of historical fill rate values which are associated with that impression parameter. Thus, for example, using the historical fill rate values (e.g., 910, FIG. 9) which are associated the Hour of Day parameter, the ad server may dynamically determine the fill rate dispersion indicator for the Hour of Day impression parameter to be about 551.48.

In at least one embodiment, the ad server may identify a filtered set of impression parameters (“Filtered Throttling Parameters”) which each have an associated fill rate dispersion indicator that meets or exceeds minimum dispersion threshold criteria. For example, in embodiments where the statistical standard deviation function is used as the fill rate dispersion indicator metric, the minimum dispersion threshold criteria may be set at a value within the range of 15-40 (e.g., 20, 22, 25, 30, etc.). Alternatively, in embodiments where the statistical variance function is used as the fill rate dispersion indicator metric, the minimum dispersion threshold criteria value may be set at a value within the range of 450-800 (e.g., 500, 525, 540, etc.).

In at least some embodiments it is preferable to select the set of Throttling Parameters which have the relatively highest fill rate dispersion indicators, since, for example, the higher the fill rate dispersion indicator for a given impression parameter, the greater the dispersion or variation of the fill rate values for that particular impression parameter; and the greater the dispersion of the fill rate values for a given impression parameter, the more effective that impression parameter may be for Impression Throttling purposes. Accordingly, in at least some embodiments, it may be preferable to set the minimum dispersion threshold criteria to an appropriate high value (e.g., some value greater than 20, for embodiments using the statistical standard deviation function).

By way of example, and for purposes of illustration, it is assumed in the example of FIG. 7 that the ad server has determined the associated fill rate dispersion indicator for each of the impression parameters shown in Table 2 (below).

TABLE 2

| | Fill Rate |
|---|---|
| Impression | Dispersion |
| Parameter | Indicator |
| Hour of Day | 23.5 |
| Day of Week | 16.4 |
| State | 26.6 |
| City | 17.5 |
| Country | 9.8 |
| ZIP | 18.5 |
| Ad Size | 19.8 |
| User ID | 5.2 |

Using the example data shown in Table 2 (above), the ad server may identify and select a filtered set of the impression parameters (herein referred to as “Filtered Throttling Parameters”) which meet or exceed a specified minimum dispersion threshold criteria value (e.g., 20). Accordingly, in this specific example, the ad server may identify the Hour of Day parameter and State parameter as each having an associated fill rate dispersion indicator that exceeds the specified minimum dispersion threshold criteria value of 20. Thus, in this example, the set of Filtered Throttling Parameters for this particular impression are the Hour of Day and State parameters, as reflected in Table 3 (below).

TABLE 3

| FILTERED | | |
|---|---|---|
| THROTTLING | | Fill |
| PARAMETER | Value | Rate % |
| Hour of Day | 11 | 65 |
| State | TX | 53 |

In other embodiments, the specific filtering criteria which may be used to identify and select the filtered set of impression parameters may include one or more of the following types of filtering rules/criteria (or combinations thereof):
exclude (e.g., filter out) any impression parameter having an associated fill rate dispersion indicator that does not meet or exceed a Minimum Dispersion Threshold Criteria (MDTC) value (e.g., MDTC=22);
select an identified impression parameter as a preferred Throttling Parameter if: (i) the identified impression parameter's associated fill rate dispersion indicator meets or exceeds a Minimum Dispersion Threshold Criteria (MDTC) value (e.g., MDTC=22), and (ii) the identified impression parameter's associated fill rate value meets or exceeds a Minimum Fill Rate (MFR) value (e.g., MFR=50%)
exclude (e.g., filter out) any impression parameter having an associated fill rate value which does not meet or exceed a Minimum Fill Rate (MFR) value (e.g., MFR=50%)
if the ad server is operating in Strict Throttling Mode, select the top n impression parameters having the relatively highest fill rate values (e.g., n=2);
if the ad server is operating in Lenient Throttling Mode, select the top m impression parameters having the relatively highest fill rate values (e.g., m=5);
if the ad server is operating in Strict Throttling Mode, select the top n % of impression parameters having the relatively highest fill rate values (e.g., n=30);
if the ad server is operating in Lenient Throttling Mode, select the top m % impression parameters having the relatively highest fill rate values (e.g., m=50);
etc.

In at least one embodiment, as shown at 710, for each Filtered Throttling Parameter which is selected, the ad server may make a determination as to whether or not the fill rate associated with corresponding impression parameter value meets or exceeds minimum threshold fill rate criteria.

Thus, for example, using the example data shown in Table 3 (above), the ad server may:
Determine if the fill rate value (e.g., 65%) associated with the Hour of Day impression parameter value (e.g., 11) meets or exceeds the minimum threshold fill rate criteria (e.g., minimum threshold fill rate=50%).
Determine if the fill rate value (e.g., 53%) associated with the State impression parameter value (e.g., TX) meets or exceeds the minimum threshold fill rate criteria (50%).

As illustrated in the example embodiment of FIG. 7, if it is determined that the respective fill rate value associated with each Filtered Throttling Parameter meets or exceeds the minimum threshold fill rate criteria, then the ad server may service (714) the received ad request/impression without using Impression Throttling. For example, according to different embodiments, the ad server may allocate its standard or full resources for servicing the ad request such as, for example, some or all of the following:

performing RTB auction;

performing one or more Adnet/S2S network auctions;

performing one or more ad campaign auctions;

performing one or more guaranteed fill auctions;

allocating full timeouts (e.g., 140 ms) for RTB calls;

allocating full timeouts (e.g., 200 ms) for Adnet/S2S network calls;

allowing multiple hops for Adnet/S2S networks;

etc.

Thereafter, as shown at 716, the results of the processed ad request/impression may be recorded, and data relating to the processed ad request/impression may be used to update one or more historical data tables such as those illustrated, for example, in FIGS. 8-12. However, in at least some embodiments, it is preferable to not use or include data relating to the processing of throttled ad requests/impressions in the updating of the historical data tables.

Alternatively, if it is determined that the respective fill rate value associated with at least one Filtered Throttling Parameter does not meet or exceed the minimum threshold fill rate criteria, then the ad server may service (712) the received ad request/impression using one or more Impression Throttling procedures.

For example, according to different embodiments, the ad server may dynamically throttle resources allocated for servicing “throttled” ad request/impressions by performing one or more of the following activities (or combinations thereof):
skip RTB auction;
skip Adnet/S2S network auction(s);
limit the number of S2S hops;
reduce the RTB timeout parameter (e.g., to 50 ms) to thereby reduce the amount of time spent in waiting for the DSPs to respond to the RTB calls;
skip calls to one or more Adnet/S2S networks;
reduce the Adnet/S2S timeout parameter (e.g., to 80 ms) to thereby reduce the amount of time spent in waiting for the Adnet/S2S network(s) to respond to the Adnet/S2S network calls;
limit or reduce the number of Adnet/S2S network hops which can be performed (e.g., limit to 1 Adnet/S2S network hop);
limit or reduce the number of Non-Beacon Based (NBBC) Adnet/S2S network hops which can be performed;
drop the ad request/impression;
etc.

In some embodiments, the various Impression Throttling procedures/activities which are implemented may depend upon one or more concurrent conditions, events, and/or parameters such as, for example, one or more of the following (or combinations thereof):
whether the ad server is currently operating in Strict Throttling Mode or Lenient Throttling Mode;
the number of Filtered Throttling Parameter(s) which does not (or which do not) meet or exceed the minimum threshold fill rate criteria;
the number of Filtered Throttling Parameter(s) which does (or which do) meet or exceed the minimum threshold fill rate criteria;
the amount of time currently remaining for the ad server to monetize the impression and respond to the ad request;
and/or other conditions, events, and/or parameters which may impact the ad server's potential revenue.

It will be appreciated that different embodiments of Impression Throttling-related Procedures described herein may include additional features and/or operations than those illustrated in the specific embodiments of FIGS. 4-7, and/or may omit at least a portion of the features and/or operations of Impression Throttling-related Procedures illustrated in the specific embodiments of FIGS. 4-7.

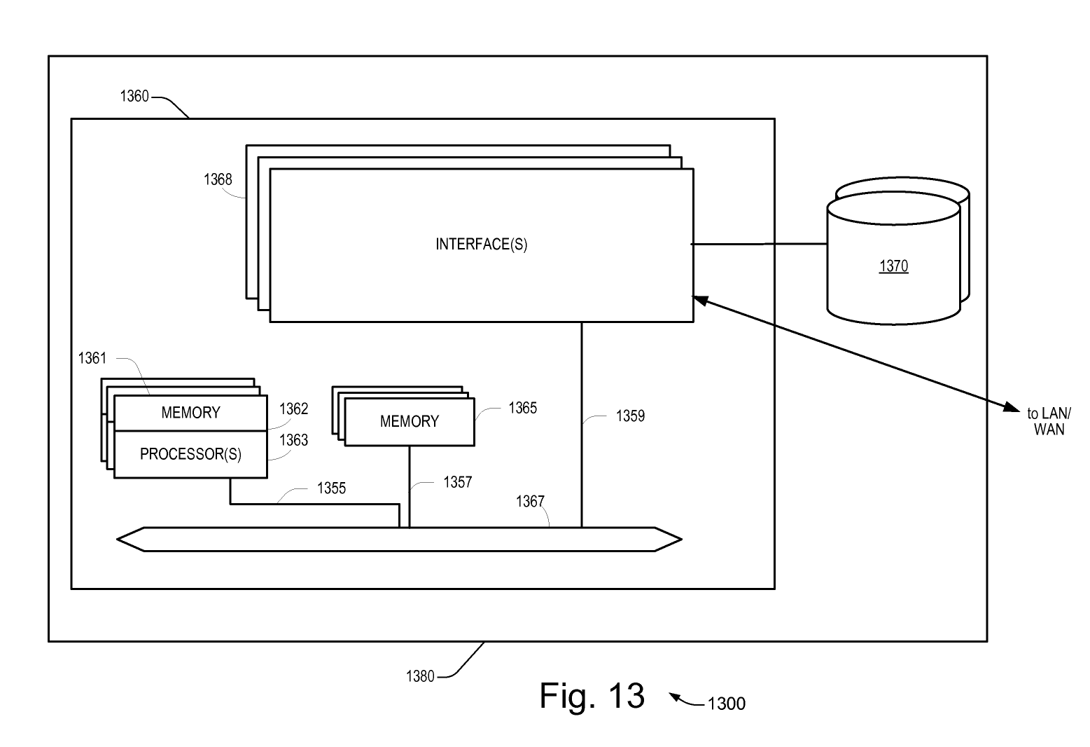

FIG. 13 illustrates an example embodiment of an ad server system 1380 which may be used for implementing various aspects/features described herein, including at least some of the various ad serving and ad auctioning techniques described herein. In at least one embodiment, the ad server system 1380 includes at least one network device 1360, and at least one storage device 1370 (such as, for example, a direct attached storage device, a local data storage device, etc.).

In at least one embodiment, storage device(s) 1370 may be configured or designed to store historical data relating to ad requests and/or impressions which have been processed by the ad server system 1380. In some embodiments, the storage device(s) 1370 may also be configured or designed to store historical data relating to ad requests and/or impressions which have been processed by other ad servers of the Advertising Service Provider System. Other data and information may be stored at one or more of the storage device(s) 1370 including at least a portion of the data, information, parameters and/or criteria disclosed herein. In some embodiments, the storage device(s) 1370 may include appropriate hardware and/or software for implementing database management functionality for defining, creating, querying, updating, and administrating one or more databases.

In according to one embodiment, network device 1360 may include a master central processing unit (CPU) 1362, interfaces 1368, and a bus 1367 (e.g., a PCI bus). When acting under the control of appropriate software or firmware, the CPU 1362 may be responsible for implementing specific functions associated with the functions of a desired network device. For example, when configured as a server, the CPU 1362 may be responsible for analyzing packets; encapsulating packets; forwarding packets to appropriate network devices; instantiating various types of virtual machines, virtual interfaces, virtual storage volumes, virtual appliances; etc. The CPU 1362 preferably accomplishes at least a portion of these functions under the control of software including an operating system (e.g. Linux), and any appropriate system software.

CPU 1362 may include one or more processors 1363 such as, for example, one or more processors from the AMD, Motorola, Intel and/or MIPS families of microprocessors. In an alternative embodiment, processor 1363 may be specially designed hardware for controlling the operations of ad server system 1380. In a specific embodiment, a memory 1361 (such as non-volatile RAM and/or ROM) also forms part of CPU 1362. However, there may be many different ways in which memory could be coupled to the system. Memory block 1361 may be used for a variety of purposes such as, for example, caching and/or storing data, programming instructions, etc.

The interfaces 1368 may be typically provided as interface cards (sometimes referred to as “line cards”). Alternatively, one or more of the interfaces 1368 may be provided as on-board interface controllers built into the system motherboard. Generally, they control the sending and receiving of data packets over the network and sometimes support other peripherals used with the ad server system 1380. Among the interfaces that may be provided may be FC interfaces, Ethernet interfaces, frame relay interfaces, cable interfaces, DSL interfaces, token ring interfaces, Infiniband interfaces, and the like. In addition, various very high-speed interfaces may be provided, such as fast Ethernet interfaces, Gigabit Ethernet interfaces, ATM interfaces, HSSI interfaces, POS interfaces, FDDI interfaces, ASI interfaces, DHEI interfaces and the like. Other interfaces may include one or more wireless interfaces such as, for example, 802.11 (WiFi) interfaces, 802.15 interfaces (including Bluetooth™) 802.16 (WiMax) interfaces, 802.22 interfaces, Cellular standards such as CDMA interfaces, CDMA2000 interfaces, WCDMA interfaces, TDMA interfaces, Cellular 3G interfaces, etc.

Generally, one or more interfaces may include ports appropriate for communication with the appropriate media. In some cases, they may also include an independent processor and, in some instances, volatile RAM. The independent processors may control such communications intensive tasks as packet switching, media control and management. By providing separate processors for the communications intensive tasks, these interfaces allow the master microprocessor 1362 to efficiently perform routing computations, network diagnostics, security functions, etc.

In at least one embodiment, some interfaces may be configured or designed to allow the ad server system 1380 to communicate with other network devices associated with various local area network (LANs) and/or wide area networks (WANs). Other interfaces may be configured or designed to allow network device 1360 to communicate with one or more direct attached storage device(s) 1370.

Although the system shown in FIG. 13 illustrates one specific network device described herein, it is by no means the only network device architecture on which one or more embodiments can be implemented. For example, an architecture having a single processor that handles communications as well as routing computations, etc. may be used. Further, other types of interfaces and media could also be used with the network device.

Regardless of network device's configuration, it may employ one or more memories or memory modules (such as, for example, memory block 1365, which, for example, may include random access memory (RAM)) configured to store data, program instructions for the general-purpose network operations and/or other information relating to the functionality of the various ad serving and ad auctioning techniques described herein. The program instructions may control the operation of an operating system and/or one or more applications, for example. The memory or memories may also be configured to store data structures, and/or other specific non-program information described herein.

Because such information and program instructions may be employed to implement the systems/methods described herein, one or more embodiments relates to machine readable media that include program instructions, state information, etc. for performing various operations described herein. Examples of machine-readable storage media include, but are not limited to, magnetic media such as hard disks, floppy disks, and magnetic tape; optical media such as CD-ROM disks; magneto-optical media such as floptical disks; and hardware devices that may be specially configured to store and perform program instructions, such as read-only memory devices (ROM) and random access memory (RAM). Examples of program instructions include both machine code, such as produced by a compiler, and files containing higher level code that may be executed by the computer using an interpreter.

Additional details relating to various aspects of online advertising technology are disclosed in the following references:

U.S. patent application Ser. No. 12/510,061, by Goel et al., titled “DYNAMIC SELECTION OF OPTIMAL ADVERTISING NETWORK”, filed Jul. 27, 2009, the entirety of which is incorporated herein by reference for all purposes.

U.S. patent application Ser. No. 14/276,548, by SURA et al., titled “INTELLIGENT AD AUCTION AND SLA COMPLIANCE TECHNIQUES”, filed May 13, 2014, the entirety of which is incorporated herein by reference for all purposes.

U.S. patent application Ser. No. 13/708,435, by KUMAR et al., titled “GRANULAR CONTROL APPLICATION FOR DELIVERING ONLINE ADVERTISING”, filed Dec. 7, 2012, the entirety of which is incorporated herein by reference for all purposes.

Although several example embodiments of one or more aspects and/or features have been described in detail herein with reference to the accompanying drawings, it is to be understood that aspects and/or features are not limited to these precise embodiments, and that various changes and modifications may be effected therein by one skilled in the art without departing from the scope of spirit of the invention(s) as defined, for example, in the appended claims.

It is claimed:

1. A computer implemented method for facilitating servicing of ad requests over an electronic data network, the method comprising causing at least one processor to execute a plurality of instructions for:
receiving, at a first ad server, a first ad request from a remote device, the first ad request including information relating to a first ad impression to be displayed in connection with a display of a first web page at an end user's device, the first web page being associated with a first publisher, the first ad request further including information relating to a first set of impression parameters associated with the first ad impression;
identifying, at the first ad server, a first impression parameter value relating to a first impression parameter of the first set of impression parameters;
dynamically determining, using the first impression parameter value, a first historical fill rate value representing an aggregate fill rate of a first set of previously processed impressions each having a respective impression parameter value which matches the first impression parameter value;
determining if the first historical fill rate value meets or exceeds a first set of minimum threshold fill rate criteria;
if it is determined that the first historical fill rate value does not meet the first set of minimum threshold fill rate criteria, processing the first ad impression at the first ad server in accordance with a first set of Impression Throttling procedures; and
wherein the processing of the first ad impression in accordance with a first set of Impression Throttling procedures causes the first ad server to dynamically reduce an amount of ad server resources allocated for processing the first ad impression.

2. The method of claim 1 wherein the processing of the first ad impression in accordance with a first set of Impression Throttling procedures includes causing the first ad server to perform at least one action selected from a group consisting of:
(a) omitting performance of a real-time bid (RTB) auction in connection with the first ad impression;
(b) reducing a timeout parameter associated with RTB ad solicitation request calls to thereby reduce an amount of time spent in waiting for responses to the RTB ad solicitation request calls to be received at the first ad server during servicing of the first ad impression;
(c) omitting performance of one or more ad solicitation request calls to one or more mobile advertising networks during servicing of the first ad impression;
(d) reducing a timeout parameter associated with mobile advertising network ad solicitation request calls to thereby reduce an amount of time spent in waiting for responses to the mobile advertising network ad solicitation request calls to be received at the first ad server during servicing of the first ad impression;
(e) reducing a Call Threshold value to thereby reduce a number of mobile advertising network ad solicitation request calls or hops to be performed by the first ad server in servicing the first ad impression; and
(f) rejecting or dropping the first ad impression.

3. The method of claim 1 further comprising causing the at least one processor to execute instructions for:
if it is determined that the first historical fill rate value meets or exceeds the first set of minimum threshold fill rate criteria, processing the first ad impression at the first ad server in accordance with a second set of procedures; and
wherein the processing of the first ad impression in accordance with a second set of Impression Throttling procedures does not causes the first ad server to dynamically reduce an amount of ad server resources allocated for processing the first ad impression.

4. The method of claim 1 further comprising causing the at least one processor to execute instructions for:
tracking, at the ad server, occurrences of timeout events which are detected during a first time interval, the timeout events relating to advertising network calls initiated by the ad server;
if it is determined that the detected occurrences of timeout events meets or exceeds a first set of threshold criteria, configuring the first set of Impression Throttling procedures to include a first set of Strict Throttling procedures; and
if it is determined that the detected occurrences of timeout events meets or exceeds a second set of threshold criteria, configuring the first set of Impression Throttling procedures to include a first set of Lenient Throttling procedures.

5. The method of claim 1 further comprising causing the at least one processor to execute instructions for:
detecting, at the ad server, an occurrence first set of events and/or conditions;
determining if the first set of events and/or conditions conforms with a first set of criteria;
determining if the first set of events and/or conditions conforms with a second set of criteria;
if it is determined that the first set of events and/or conditions conforms with the first set of criteria, enabling use of Impression Throttling procedures at the ad server in connection with processing of incoming ad impressions; and
if it is determined that the first set of events and/or conditions conforms with the second set of criteria, disabling use of Impression Throttling procedures at the ad server in connection with processing of incoming ad impressions.

6. The method of claim 1 further comprising causing the at least one processor to execute instructions for:
identifying, at the first ad server, a second impression parameter value relating to a second impression parameter of the second set of impression parameters;
dynamically determining, using the second impression parameter value, a second historical fill rate value representing an aggregate fill rate of a second set of previously processed impressions each having a respective impression parameter value which matches the second impression parameter value;
determining if the second historical fill rate value meets or exceeds a second set of minimum threshold fill rate criteria;
if it is determined that the second historical fill rate value does not meet the second set of minimum threshold fill rate criteria, processing the first ad impression at the first ad server in accordance with a second set of Impression Throttling procedures; and
wherein the processing of the first ad impression in accordance with a second set of Impression Throttling procedures causes the first ad server to dynamically reduce an amount of ad server resources allocated for processing the first ad impression.

7. A computer implemented method for facilitating servicing of ad requests over an electronic data network, the method comprising causing at least one processor to execute a plurality of instructions for:
receiving, at a first ad server, a first ad request from a remote device, the first ad request including information relating to a first ad impression to be displayed in connection with a display of a first web page at an end user's device, the first web page being associated with a first publisher, the first ad request further including information relating to a first set of impression parameters associated with the first ad impression;
identifying, at the first ad server, a first impression parameter value relating to a first impression parameter of the first set of impression parameters;
dynamically determining, using the first impression parameter value, a first historical fill rate value representing an aggregate fill rate of a first set of previously processed impressions each having a respective impression parameter value which matches the first impression parameter value;
determining if the first historical fill rate value satisfies a first set of minimum threshold fill rate criteria;
determining, using historical fill rate information relating to the first impression parameter, a first fill rate dispersion indicator relating to the first impression parameter, the first fill rate dispersion indicator being indicative of an amount of variation or dispersion relating to a distribution of historical fill rate values associated with the first impression parameter;
determining if the first fill rate dispersion indicator satisfies minimum dispersion threshold criteria;
if it is determined that the first fill rate dispersion indicator satisfies the minimum dispersion threshold criteria, and if it is determined that the first historical fill rate value does not satisfy the first set of minimum threshold fill rate criteria, processing the first ad impression at the first ad server in accordance with a first set of Impression Throttling procedures; and
wherein the processing of the first ad impression in accordance with a first set of Impression Throttling procedures causes the first ad server to dynamically reduce an amount of ad server resources allocated for processing the first ad impression.

8. The method of claim 7 wherein, if it is determined that the first fill rate dispersion indicator does not satisfy the minimum dispersion threshold criteria, causing the at least one processor to execute additional instructions for:
identifying, at the first ad server, a second impression parameter value relating to a second impression parameter of the second set of impression parameters;
dynamically determining, using the second impression parameter value, a second historical fill rate value representing an aggregate fill rate of a second set of previously processed impressions each having a respective impression parameter value which matches the second impression parameter value;
determining if the second historical fill rate value satisfies the first set of minimum threshold fill rate criteria;
determining, using historical fill rate information relating to the second impression parameter, a second fill rate dispersion indicator relating to the second impression parameter, the second fill rate dispersion indicator being indicative of an amount of variation or dispersion relating to a distribution of historical fill rate values associated with the second impression parameter;
determining if the second fill rate dispersion indicator satisfies the minimum dispersion threshold criteria; and
if it is determined that the second fill rate dispersion indicator satisfies the minimum dispersion threshold criteria, and if it is determined that the second historical fill rate value does not satisfy the first set of minimum threshold fill rate criteria, processing the first ad impression at the first ad server in accordance with the first set of Impression Throttling procedures.

9. The method of claim 7 wherein the processing of the first ad impression in accordance with a first set of Impression Throttling procedures includes causing the first ad server to perform at least one action selected from a group consisting of:
(a) omitting performance of a real-time bid (RTB) auction in connection with the first ad impression;
(b) reducing a timeout parameter associated with RTB ad solicitation request calls to thereby reduce an amount of time spent in waiting for responses to the RTB ad solicitation request calls to be received at the first ad server during servicing of the first ad impression;
(c) omitting performance of one or more ad solicitation request calls to one or more mobile advertising networks during servicing of the first ad impression;
(d) reducing a timeout parameter associated with mobile advertising network ad solicitation request calls to thereby reduce an amount of time spent in waiting for responses to the mobile advertising network ad solicitation request calls to be received at the first ad server during servicing of the first ad impression;
(e) reducing a Call Threshold value to thereby reduce a number of mobile advertising network ad solicitation request calls or hops to be performed by the first ad server in servicing the first ad impression; and
(f) rejecting or dropping the first ad impression.

10. The method of claim 7 further comprising causing the at least one processor to execute instructions for:
if it is determined that the first historical fill rate value meets or exceeds the first set of minimum threshold fill rate criteria, processing the first ad impression at the first ad server in accordance with a second set of procedures; and
wherein the processing of the first ad impression in accordance with a second set of Impression Throttling procedures does not causes the first ad server to dynamically reduce an amount of ad server resources allocated for processing the first ad impression.

11. The method of claim 7 further comprising causing the at least one processor to execute instructions for:
tracking, at the ad server, occurrences of timeout events which are detected during a first time interval, the timeout events relating to advertising network calls initiated by the ad server;
if it is determined that the detected occurrences of timeout events meets or exceeds a first set of threshold criteria, configuring the first set of Impression Throttling procedures to include a first set of Strict Throttling procedures; and
if it is determined that the detected occurrences of timeout events meets or exceeds a second set of threshold criteria, configuring the first set of Impression Throttling procedures to include a first set of Lenient Throttling procedures.

12. The method of claim 7 further comprising causing the at least one processor to execute instructions for:
detecting, at the ad server, an occurrence first set of events and/or conditions;
determining if the first set of events and/or conditions conforms with a first set of criteria;
determining if the first set of events and/or conditions conforms with a second set of criteria;
if it is determined that the first set of events and/or conditions conforms with the first set of criteria, enabling use of Impression Throttling procedures at the ad server in connection with processing of incoming ad impressions; and
if it is determined that the first set of events and/or conditions conforms with the second set of criteria, disabling use of Impression Throttling procedures at the ad server in connection with processing of incoming ad impressions.

13. A computer implemented system for facilitating servicing of ad requests over an electronic data network, the system comprising causing at least one processor to execute a plurality of instructions for:
receiving, at a first ad server, a first ad request from a remote device, the first ad request including information relating to a first ad impression to be displayed in connection with a display of a first web page at an end user's device, the first web page being associated with a first publisher, the first ad request further including information relating to a first set of impression parameters associated with the first ad impression;
identifying, at the first ad server, a first impression parameter value relating to a first impression parameter of the first set of impression parameters;
dynamically determining, using the first impression parameter value, a first historical fill rate value representing an aggregate fill rate of a first set of previously processed impressions each having a respective impression parameter value which matches the first impression parameter value;
determining if the first historical fill rate value satisfies a first set of minimum threshold fill rate criteria;
determining, using historical fill rate information relating to the first impression parameter, a first fill rate dispersion indicator relating to the first impression parameter, the first fill rate dispersion indicator being indicative of an amount of variation or dispersion relating to a distribution of historical fill rate values associated with the first impression parameter;
determining if the first fill rate dispersion indicator satisfies minimum dispersion threshold criteria;
if it is determined that the first fill rate dispersion indicator satisfies the minimum dispersion threshold criteria, and if it is determined that the first historical fill rate value does not satisfy the first set of minimum threshold fill rate criteria, processing the first ad impression at the first ad server in accordance with a first set of Impression Throttling procedures; and
wherein the processing of the first ad impression in accordance with a first set of Impression Throttling procedures causes the first ad server to dynamically reduce an amount of ad server resources allocated for processing the first ad impression.

14. The system of claim 13 wherein, if it is determined that the first fill rate dispersion indicator does not satisfy the minimum dispersion threshold criteria, causing the at least one processor to execute additional instructions for:
identifying, at the first ad server, a second impression parameter value relating to a second impression parameter of the second set of impression parameters;
dynamically determining, using the second impression parameter value, a second historical fill rate value representing an aggregate fill rate of a second set of previously processed impressions each having a respective impression parameter value which matches the second impression parameter value;
determining if the second historical fill rate value satisfies the first set of minimum threshold fill rate criteria;
determining, using historical fill rate information relating to the second impression parameter, a second fill rate dispersion indicator relating to the second impression parameter, the second fill rate dispersion indicator being indicative of an amount of variation or dispersion relating to a distribution of historical fill rate values associated with the second impression parameter;
determining if the second fill rate dispersion indicator satisfies the minimum dispersion threshold criteria; and
if it is determined that the second fill rate dispersion indicator satisfies the minimum dispersion threshold criteria, and if it is determined that the second historical fill rate value does not satisfy the first set of minimum threshold fill rate criteria, processing the first ad impression at the first ad server in accordance with the first set of Impression Throttling procedures.

15. The system of claim 13 wherein the processing of the first ad impression in accordance with a first set of Impression Throttling procedures includes causing the at least one processor to execute instructions for performing at least one action selected from a group consisting of:
(a) omitting performance of a real-time bid (RTB) auction in connection with the first ad impression;
(b) reducing a timeout parameter associated with RTB ad solicitation request calls to thereby reduce an amount of time spent in waiting for responses to the RTB ad solicitation request calls to be received at the first ad server during servicing of the first ad impression;
(c) omitting performance of one or more ad solicitation request calls to one or more mobile advertising networks during servicing of the first ad impression;
(d) reducing a timeout parameter associated with mobile advertising network ad solicitation request calls to thereby reduce an amount of time spent in waiting for responses to the mobile advertising network ad solicitation request calls to be received at the first ad server during servicing of the first ad impression;
(e) reducing a Call Threshold value to thereby reduce a number of mobile advertising network ad solicitation request calls or hops to be performed by the first ad server in servicing the first ad impression; and
(f) rejecting or dropping the first ad impression.

16. The system of claim 13 being further operable to cause the at least one processor to execute instructions for:
if it is determined that the first historical fill rate value meets or exceeds the first set of minimum threshold fill rate criteria, processing the first ad impression at the first ad server in accordance with a second set of procedures; and
wherein the processing of the first ad impression in accordance with a second set of Impression Throttling procedures does not causes the first ad server to dynamically reduce an amount of ad server resources allocated for processing the first ad impression.

17. The system of claim 13 being further operable to cause the at least one processor to execute instructions for:
tracking, at the ad server, occurrences of timeout events which are detected during a first time interval, the timeout events relating to advertising network calls initiated by the ad server;
if it is determined that the detected occurrences of timeout events meets or exceeds a first set of threshold criteria, configuring the first set of Impression Throttling procedures to include a first set of Strict Throttling procedures; and
if it is determined that the detected occurrences of timeout events meets or exceeds a second set of threshold criteria, configuring the first set of Impression Throttling procedures to include a first set of Lenient Throttling procedures.

18. The system of claim 13 being further operable to cause the at least one processor to execute instructions for:
detecting, at the ad server, an occurrence first set of events and/or conditions;
determining if the first set of events and/or conditions conforms with a first set of criteria;
determining if the first set of events and/or conditions conforms with a second set of criteria;
if it is determined that the first set of events and/or conditions conforms with the first set of criteria, enabling use of Impression Throttling procedures at the ad server in connection with processing of incoming ad impressions; and
if it is determined that the first set of events and/or conditions conforms with the second set of criteria, disabling use of Impression Throttling procedures at the ad server in connection with processing of incoming ad impressions.
